(19) United States
(12) Patent Application Publication
(10) Pub. No.: US 2026/0171060 A1
(43) Pub. Date: Jun. 18, 2026

(54) ELECTRONIC WIND INSTRUMENT AND METHOD FOR PROVIDING OPERATION FEEL

(71) Applicant: Roland Corporation, Shizuoka (JP)

(72) Inventors: Rin YAEGASHI, Hamamatsu (JP); Kentaro MORI, Hamamatsu (JP); Masato SHIMIZU, Hamamatsu (JP)

(73) Assignee: Roland Corporation, Shizuoka (JP)

(21) Appl. No.: 19/402,999

(22) Filed: Nov. 27, 2025

(30) Foreign Application Priority Data
Dec. 12, 2024 (JP) 2024-218224
Sep. 12, 2025 (JP) 2025-152030

(51) Int. Cl. G10H 1/34

(52) U.S. Cl. CPC G10H 1/344; G10H 2220/265; G10H 2230/195

(57) ABSTRACT

An electronic wind instrument according to an embodiment of the disclosure includes: a housing; an operator supported on outside of the housing to be rotatable in a pressing direction approaching the housing and a return direction opposite to the pressing direction; a detection portion detecting an operation to the operator; and a return-side stopper restricting a rotation of the operator in the return direction, in which the detection portion includes a movable portion that moves with a rotation of the operator and an elastic body that generates a repulsive force for rotating the operator in the return direction via the movable portion, and the repulsive force of the elastic body is applied to the operator in a state where a rotation of the operator in the return direction is restricted by the return-side stopper.

### CROSS-REFERENCE TO RELATED APPLICATION

This application claims the priority benefits of Japan application serial no. 2024-218224, filed on Dec. 12, 2024 and Japan application serial no. 2025-152030, filed on Sep. 12, 2025. The entirety of the above-mentioned patent application is hereby incorporated by reference herein and made a part of this specification.

### BACKGROUND

### Technical Field

The disclosure relates to an electronic wind instrument and a method for providing operation feel, and particularly relates to an electronic wind instrument and a method for providing operation feel that are capable of bringing the operation feel of an operator close to the operation feel of an acoustic wind instrument.

### Description of Related Art

For example, Patent Document 1 (Japanese Patent Application Laid-Open No. 2010-60885 (for example, paragraphs 0009 to 0021, and FIG. 1 to FIG. 4)) describes an electronic wind instrument in which an operator 20 is rotatably mounted to the outside of a tube body 10 (housing). In this electronic wind instrument, in the case of the operator 20 being pressed by the performer, a movable portion 34 of a detection body 30 (switch) provided directly below is pressed against the repulsive force of an elastic body 44, thereby turning on the detection body 30. Further, Patent Document 2 (Japanese Patent Application Laid-Open No. H1-243097 (for example, line 1 in the right lower column on page 2 to line 17 in the left upper column on page 4, and FIG. 1 and FIG. 2)) describes an electronic wind instrument in which a key 71 (operator) is rotatably mounted to the outside of a body 65 (housing). In this electronic wind instrument, in the case of the key 71 being pressed by the performer, a sheet-like switch 93 (detection portion) is pressed and turned on via an actuator 75 (movable portion) that is provided to be vertically movable in the body 65. In the case where the key 71 is not pressed, the key 71 tends to rotate in a direction away from the body 65 due to the repulsive force of a return spring 79, but the rotation is restricted by a stopper 77 provided in the key 71.

However, in the above-described Patent Document 1, the operator 20 is merely placed on the movable portion 34, so in the case where the performer is not pressing the operator 20, the operator 20 and the movable portion 34 separate or contact again. Further, in Patent Document 2, in the case where the performer is not pressing the key 71 (operator), the key 71 is separated from the actuator 75 (movable portion). In the case of the performer pressing the operator in a state where the operator and the movable portion are separated, differences in pressing feel (reaction force) caused by spanning contact/non-contact of those components occur. An acoustic wind instrument does not have such differences in pressing feel. Therefore, there is a problem that the operation feel of the operator is far from the operation feel of an acoustic wind instrument.

### SUMMARY

An electronic wind instrument according to an embodiment of the disclosure includes: a housing; an operator supported on outside of the housing to be rotatable in a pressing direction approaching the housing and a return direction opposite to the pressing direction; a detection portion detecting an operation to the operator; and a return-side stopper restricting a rotation of the operator in the return direction, in which the detection portion includes a movable portion that moves with a rotation of the operator and an elastic body that generates a repulsive force for rotating the operator in the return direction via the movable portion, and the repulsive force of the elastic body is applied to the operator in a state where a rotation of the operator in the return direction is restricted by the return-side stopper.

A method for providing operation feel according to an embodiment of the disclosure is provided for an operator in an electronic wind instrument that includes: a housing; the operator supported on outside of the housing to be rotatable in a pressing direction approaching the outside of the housing and a return direction opposite to the pressing direction; a detection portion detecting an operation to the operator; and a return-side stopper restricting a rotation of the operator in the return direction, in which the detection portion includes a movable portion that moves with a rotation of the operator and an elastic body that generates a repulsive force for rotating the operator in the return direction via the movable portion. The method includes: applying the repulsive force of the elastic body to the operator in a state where a rotation in the return direction is restricted by the return-side stopper.

### BRIEF DESCRIPTION OF THE DRAWINGS

FIG. 1A is a perspective view of the electronic wind instrument of the first embodiment.

FIG. 1B is a partially enlarged perspective view of the electronic wind instrument showing a state where the instrument body is disassembled.

FIG. 2 is an exploded perspective view of the air inlet unit.

FIG. 3A is a perspective view of the lip plate viewed from the inner circumferential side.

FIG. 3B is a partially enlarged cross-sectional view of the air inlet unit.

FIG. 4 is a partially enlarged cross-sectional view of the air inlet unit taken along line IV-IV of FIG. 3B.

FIG. 5A is a partially enlarged cross-sectional view of the air inlet unit taken along line Va-Va of FIG. 4.

FIG. 5B is a partially enlarged cross-sectional view of the air inlet unit taken along line Vb-Vb of FIG. 4.

FIG. 6 is a partially enlarged perspective view of the electronic wind instrument showing a state where the instrument body is disassembled and the operators are removed.

FIG. 7A is a cross-sectional view of the electronic wind instrument at a position including the first lid operator in a non-pressed state.

FIG. 7B is a cross-sectional view of the electronic wind instrument at a position including the first lid operator in a pressed state.

FIG. 8A is a cross-sectional view of the electronic wind instrument at a position including the second lid operator in a non-pressed state.

FIG. 8B is a cross-sectional view of the electronic wind instrument at a position including the first lever operator in a non-pressed state.

FIG. 9A is a cross-sectional view of the electronic wind instrument at a position including the second lever operator in a non-pressed state.

FIG. 9B is a schematic view showing the relationship between the rotation range of each operator and the movable range of the switch.

FIG. 10A is a partially enlarged top view of the electronic wind instrument.

FIG. 10B is a cross-sectional view of the electronic wind instrument taken along line Xb-Xb of FIG. 10A.

FIG. 11A is a cross-sectional view of the electronic wind instrument taken along line XIa-XIa of FIG. 10A.

FIG. 11B is a cross-sectional view of the electronic wind instrument taken along line XIb-XIb of FIG. 10A.

FIG. 12 is a partially enlarged cross-sectional view of the electronic wind instrument of the second embodiment.

FIG. 13A is a partially enlarged top view of the electronic wind instrument of the third embodiment.

FIG. 13B is a partially enlarged cross-sectional view of the electronic wind instrument taken along line XIIIb-XIIIb of FIG. 13A.

FIG. 14A is a cross-sectional view of the electronic wind instrument of the fourth embodiment.

FIG. 14B is a cross-sectional view of the electronic wind instrument of the fifth embodiment.

### DESCRIPTION OF THE EMBODIMENTS

The disclosure provides an electronic wind instrument and a method for providing operation feel that are capable of bringing the operation feel of an operator close to the operation feel of an acoustic wind instrument.

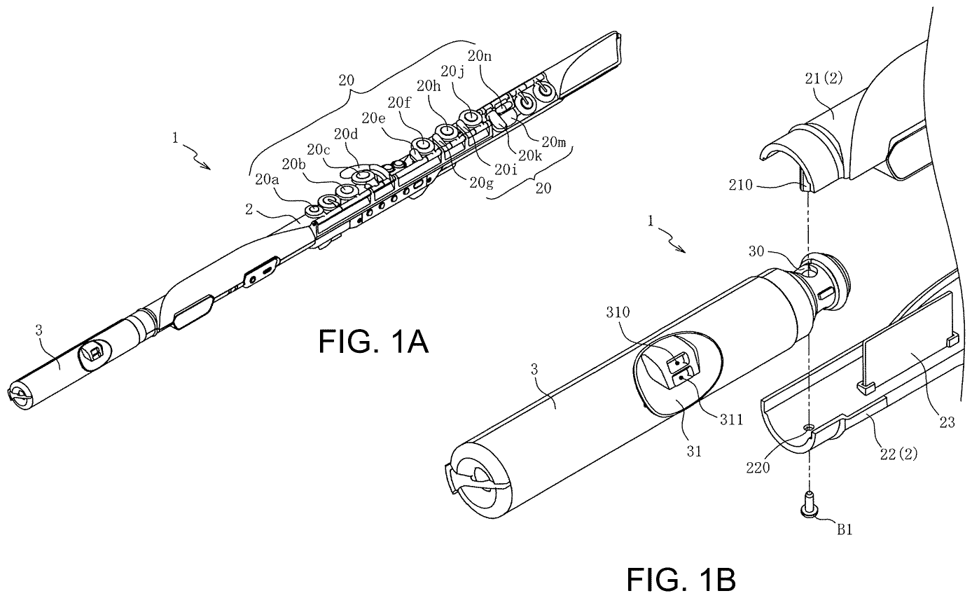

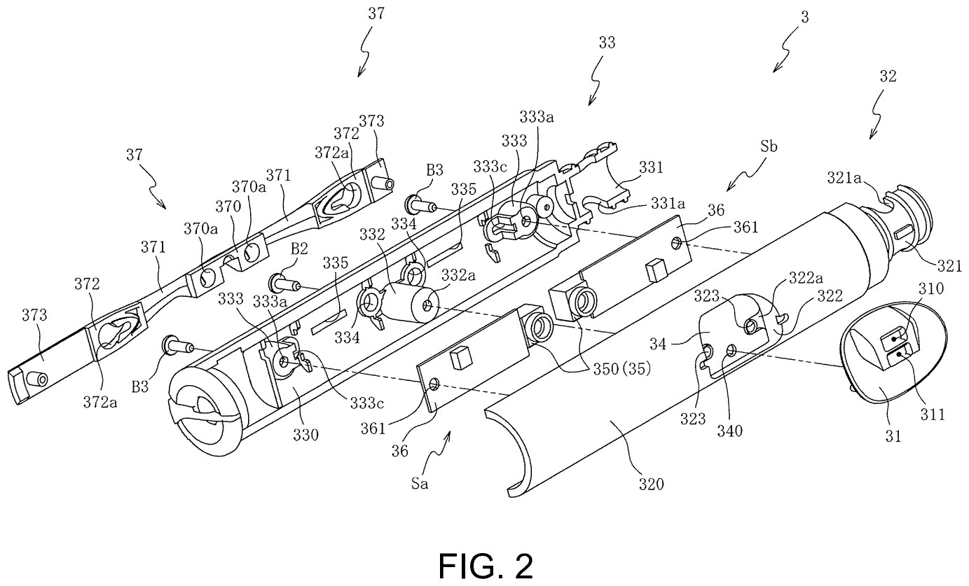

Hereinafter, exemplary embodiments will be described with reference to the accompanying drawings. First, with reference to FIG. 1A to FIG. 2, the overall configuration of the electronic wind instrument 1 of the first embodiment will be described. FIG. 1A is a perspective view of the electronic wind instrument 1 of the first embodiment, and FIG. 1B is a partially enlarged perspective view of the electronic wind instrument 1 showing a state where the instrument body 2 is disassembled. FIG. 2 is an exploded perspective view of the air inlet unit 3. It is noted that, in the following description, a direction orthogonal to the axial direction (longitudinal direction) of the electronic wind instrument 1 is described as the radial direction, and a direction around the axis is described as the circumferential direction.

As shown in FIG. 1A and FIG. 1B, the electronic wind instrument 1 is an electronic musical instrument that imitates an acoustic wind instrument (in this embodiment, a flute). The electronic wind instrument 1 includes an instrument body 2 that imitates a body tube and a foot joint of a flute, and an air inlet unit 3 that imitates a head joint is mounted to an end portion in the axial direction of the instrument body 2.

The instrument body 2 includes substantially semi-cylindrical upper housing 21 (first housing) and lower housing 22 (second housing), and multiple operators 20 that are respectively operated by a performer are mounted to an outer circumferential surface of the upper housing 21. The multiple operators 20 specifically include five first lid operators 20a, 20b, 20f, 20h, and 20j, one second lid operator 20c, one first lever operator 20d, four second lever operators 20e, 20g, 20i, and 20k, one first interlocking operator 20m, and one second interlocking operator 20n.

The electronic wind instrument 1 is configured to acquire an on state (pressed state) in the case of each of the multiple operators 20a to 20n being pushed toward the upper housing 21 by a performer, and to acquire an off state (non-pressed state) in the case of the multiple operators 20a to 20n not being pushed. Furthermore, a pitch based on the acquired on/off state is applied to a musical sound to be generated.

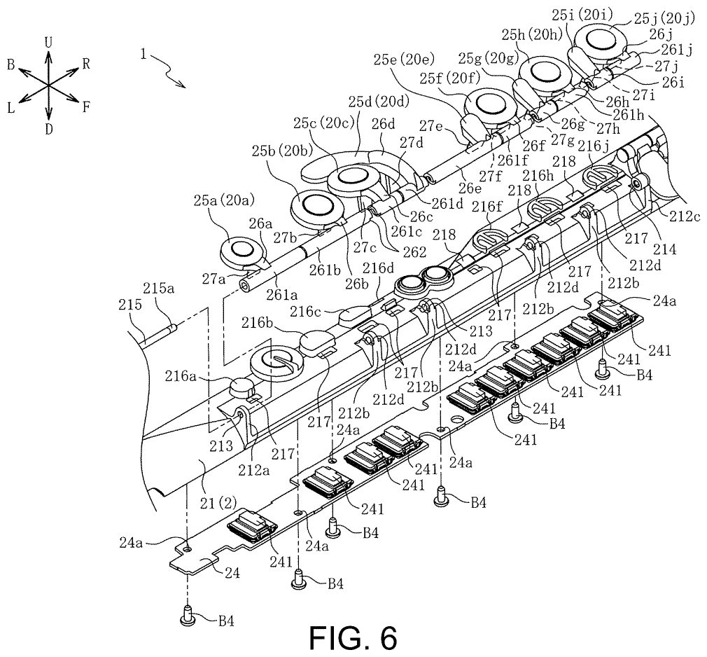

It is noted that the operators 20a to 20n are not limited to the above-described thirteen elements, and may be twelve or fewer elements or fourteen or more elements, and some of the operators 20a to 20n may be mounted to an outer circumferential surface of the lower housing 22 or the like. Further, more detailed structures of the operators 20a to 20n will be described with reference to FIG. 6 to FIG. 11B.

A columnar protrusion 210 (boss) is integrally formed at an end portion of the upper housing 21 on the air inlet unit 3 side in the axial direction. The protrusion 210 protrudes from an inner circumferential surface of the upper housing 21 toward the lower housing 22, and a through hole 220 for passing a bolt B1 is formed in the lower housing 22 at a position corresponding to a tip end of the protrusion 210.

An insertion hole 30 for inserting the protrusion 210 of the upper housing 21 is formed at an end portion of the air inlet unit 3 on the instrument body 2 side in the axial direction, and a bolt hole (fastening hole) (not shown) is formed at the tip end of the protrusion 210 of the upper housing 21. The air inlet unit 3 is mounted to the instrument body 2 by screwing a bolt B1 passing through the through hole 220 into the protrusion 210 in a state where the protrusion 210 of the upper housing 21 is inserted into the insertion hole 30 of the air inlet unit 3.

A lip plate 31 is mounted to an outer circumferential surface of the air inlet unit 3, and an upper air inlet 310 (first air inlet) and a lower air inlet 311 (second air inlet) are formed in the lip plate 31 and arranged side by side in a circumferential direction. Each of these air inlets 310 and 311 is a rectangular opening formed to be horizontally long in the axial direction of the air inlet unit 3. Performance of the electronic wind instrument 1 is carried out by the performer switching the blowing direction of exhaled air to each air inlet 310 and 311 (blowing separately) while operating the operators 20.

Electronic components such as a substrate 23 are housed in an internal space surrounded by the housings 21 and 22 of the instrument body 2. A CPU is provided on the substrate 23, and musical sounds are generated based on the operation states of the operators 20 and the exhaled air blowing state (blowing amount) to each air inlet 310 and 311 by musical sound generation processing executed by this CPU.

As shown in FIG. 2, the air inlet unit 3 includes a substantially semi-cylindrical air inlet side housing 32 (third housing) and an exhaust side housing 33 (fourth housing). Each of these housings 32 and 33 is a resin component that includes a large diameter portion 320 and 330 having a relatively large diameter, and a small diameter portion 321 and 331 formed on one end side in the axial direction of the large diameter portion 320 and 330 and having a smaller diameter than the large diameter portion 320 and 330.

The large diameter portion 320 and the small diameter portion 321 of the air inlet side housing 32 are integrally formed, and similarly, the exhaust side housing 33 also has the large diameter portion 330 and the small diameter portion 331 integrally formed. Semi-elliptical notches 321a and 331a are formed at two end portions in the circumferential direction of the small diameter portions 321 and 331 of the housings 32 and 33, respectively, and by stacking the housings 32 and 33 together, the above-mentioned insertion hole 30 (see FIG. 1B) is formed.

A mounting hole 322 for mounting the lip plate 31 is formed in the large diameter portion 320 of the air inlet side housing 32, and a substrate 34 is sandwiched between a bottom surface 322a of this mounting hole 322 and the lip plate 31. The substrate 34 is for heating the lip plate 31 to remove moisture, and details of the configuration related to this heating will be described later.

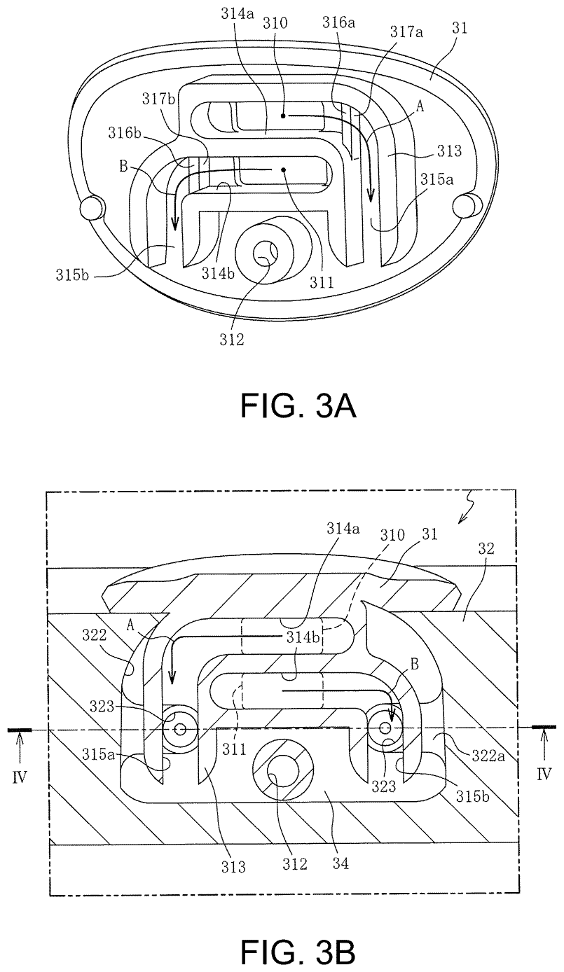

A boss 332 for fixing the lip plate 31 is integrally formed on an inner circumferential surface of the large diameter portion 330 of the exhaust side housing 33. The boss 332 is a cylindrical protrusion that rises from the inner circumferential surface of the large diameter portion 330 toward the air inlet side housing 32 side. An insertion hole 332a for inserting a bolt B2 is formed at the center of the boss 332, and a similar insertion hole 340 is also formed in the substrate 34 (bottom surface 322a of the mounting hole 322). By screwing the bolt B2 inserted into the insertion holes 332a and 340 of the boss 332 and the substrate 34 into a bolt hole 312 (see FIG. 3B) of the lip plate 31, the lip plate 31 is fixed to the mounting hole 322 (outer circumferential surface) of the air inlet side housing 32.

Housing side flow paths 323 for passing exhaled air blown from the air inlets 310 and 311 are formed on the bottom surface 322a of the mounting hole 322. The housing side flow paths 323 are formed as a pair spaced apart in an axial direction of the air inlet side housing 32 (air inlet unit 3). The exhaled air that has passed through this pair of housing side flow paths 323 is introduced into a pair of sensor modules Sa and Sb.

The pair of sensor modules Sa and Sb are arranged symmetrically with a plane orthogonal to the axial direction of the air inlet unit 3 (a plane including the air inlets 310 and 311) as a plane of symmetry (hereinafter, such symmetry is simply referred to as “symmetrical”). The sensor module Sa detects exhaled air blown into the upper air inlet 310, and the sensor module Sb detects exhaled air blown into the lower air inlet 311. The sensor modules Sa and Sb are identical components, respectively, and include a resin case 35 and a substrate 36 mounted to the case 35 by adhesion or the like.

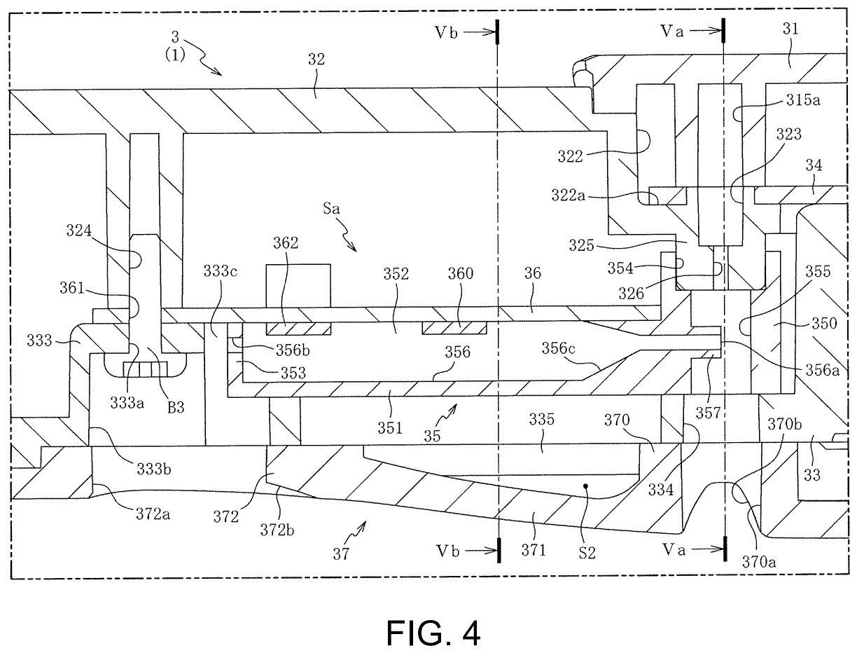

Each case 35 of the sensor modules Sa and Sb is formed with a cylindrical cylinder portion 350 through which exhaled air blown from the air inlets 310 and 311 passes, and the exhaled air that has passed through this cylinder portion 350 is detected by a temperature sensor 360 (see FIG. 4) provided on the substrate 36. Details of this exhaled air detection method will be described later.

Bosses 333 for fixing the pair of sensor modules Sa and Sb are integrally formed on the inner circumferential surface at two ends side in the axial direction of the exhaust side housing 33. The boss 333 is a cylindrical protrusion that rises toward the air inlet side housing 32 side, and an insertion hole 333a for passing a bolt B3 is formed at the center of the boss 333.

A similar insertion hole 361 is formed at an end portion of the substrate 36 on the opposite side from the cylinder portion 350 in the axial direction, and a bolt hole 324 (see FIG. 4) is formed on the inner circumferential surface of the air inlet side housing 32 at a position corresponding to the boss 333 (insertion hole 333a). By screwing the bolt B3 inserted into the insertion holes 333a and 361 of the boss 333 and the substrate 36 into the bolt hole 324 of the air inlet side housing 32, the sensor modules Sa and Sb are fixed inside the air inlet unit 3.

In this fixed state, the cylinder portion 350 of the sensor modules Sa and Sb and the first exhaust port 334 of the exhaust side housing 33 communicate with each other. The first exhaust ports 334 are provided in a pair with an interval in the axial direction (with the boss 332 interposed therebetween), and exhaled air blown into the air inlets 310 and 311 is mainly discharged from these first exhaust ports 334. A pair of second exhaust ports 335 are formed on two sides in the axial direction of the pair of first exhaust ports 334. Each of these exhaust ports 334 and 335 is a hole that penetrates the large diameter portion 330 of the exhaust side housing 33, the first exhaust port 334 is formed in a circular shape, and the second exhaust port 335 is formed in a rectangular shape that is long in the axial direction.

Each exhaust port 334 and 335 is covered by a decorative body 37 (covering member) that extends in the axial direction. The decorative body 37 includes a first covering portion 370 that covers the first exhaust port 334, and a through hole 370a is formed in the first covering portion 370 at a position corresponding to the first exhaust port 334. A pair of second covering portions 371 that cover the pair of second exhaust ports 335 are provided on two sides in the axial direction of the first covering portion 370, and a pair of third covering portions 372 are provided on two sides in the axial direction of the pair of second covering portions 371.

The third covering portion 372 is a portion that covers a recess portion 333b (see FIG. 4) formed on the outer circumferential surface of the exhaust side housing 33 by the boss 333, and a through hole 372a is formed in the third covering portion 372 at a position corresponding to the recess portion 333b. A pair of fixed portions 373 are provided on two sides in the axial direction of the pair of third covering portions 372, and the pair of fixed portions 373 are fixed to the outer circumferential surface of the exhaust side housing 33 (large diameter portion 330) by bolts (not shown).

Each portion 370 to 373 constituting the decorative body 37 is integrally formed using a resin material. By covering each exhaust port 334 and 335 and recess portion 333b (see FIG. 4) with each portion 370 to 373 of the decorative body 37, the appearance of the electronic wind instrument 1 may be improved.

Next, with reference to FIG. 2 to FIG. 3B, the flow path of exhaled air from each air inlet 310 and 311 to the pair of housing side flow paths 323 will be described. FIG. 3A is a perspective view of the lip plate 31 viewed from the inner side, and FIG. 3B is a partially enlarged cross-sectional view of the air inlet unit 3 (electronic wind instrument 1). FIG. 3B shows a cross-section taken along a plane that is orthogonal to the blowing direction of exhaled air into the air inlets 310 and 311 by the performer (radial direction of the air inlet side housing 32) and includes the barrier wall 313 of the lip plate 31.

It is noted that FIG. 3B is a cross-sectional view that does not include each air inlet 310 and 311 or restricted walls 317a and 317b (see FIG. 3A), but in FIG. 3B, the positions where the air inlets 310 and 311 are formed are shown by broken lines. Further, in the following description, the side of each air inlet 310 and 311 is referred to as the upstream side of the exhaled air flow path, and the opposite side is referred to as the downstream side.

As shown in FIG. 2 to FIG. 3B, a barrier wall 313 that partitions the flow path of exhaled air is integrally formed on the inner surface of the lip plate 31. The barrier wall 313 is formed in a wall shape that rises from the inner surface of the lip plate 31, and the tip end of this barrier wall 313 (the end portion on the far side in the perpendicular direction to the paper surface of FIG. 3B) is configured to contact the substrate 34. The first bent flow paths 314a and 314b and the second bent flow paths 315a and 315b are formed by the space surrounded by this barrier wall 313 and the substrate 34.

The first bent flow path 314a is a flow path that extends linearly from the upper air inlet 310 to one side in the axial direction of the air inlet side housing 32 (left side in FIG. 3B). From the downstream end portion (left side in FIG. 3B) of the first bent flow path 314a, the second bent flow path 315a bends perpendicularly (in the circumferential direction of the air inlet side housing 32), and the portion at the downstream side of this second bent flow path 315a is connected to one of the pair of housing side flow paths 323.

The first bent flow path 314b is a flow path that extends linearly from the lower air inlet 311 to the other side in the axial direction of the air inlet side housing 32 (right side in FIG. 3B). From the end portion at the downstream side (right side in FIG. 3B) of the first bent flow path 314b, the second bent flow path 315b bends perpendicularly (in the circumferential direction of the air inlet side housing 32 and in the same direction as the second bent flow path 315a), and the portion at the downstream side of this second bent flow path 315b is connected to the other housing side flow path 323.

Further, a restricted flow path 316a (see FIG. 3A) is formed at the boundary part between the first bent flow path 314a and the second bent flow path 315a, and a restricted flow path 316b is also formed at the boundary part between the first bent flow path 314b and the second bent flow path 315b. These restricted flow paths 316a and 316b are formed by restricted walls 317a and 317b that connect the walls of the barrier wall 313.

The restricted walls 317a and 317b are walls that extend to cross each bent flow path 314a, 314b, 315a, and 315b, and the erected height of the restricted walls 317a and 317b from the inner surface of the lip plate 31 is formed lower than the erected height of the barrier wall 313. By forming these restricted walls 317a and 317b, restricted flow paths 316a and 316b having a smaller flow path cross-sectional area than each bent flow path 314a, 314b, 315a, and 315b are formed.

As shown by arrow A in FIG. 3A and FIG. 3B, the exhaled air blown from the upper air inlet 310 is introduced into one housing side flow path 323 through the first bent flow path 314a, the restricted flow path 316a, and the second bent flow path 315a. On the other hand, as shown by arrow B, the exhaled air blown from the lower air inlet 311 is introduced into the other housing side flow path 323 through the first bent flow path 314b, the restricted flow path 316b, and the second bent flow path 315b.

Next, with reference to FIG. 3A to FIG. 4, the exhaled air flow path from the housing side flow paths 323 to the first exhaust port 334 will be described. FIG. 4 is a partially enlarged cross-sectional view of the air inlet unit 3 taken along line IV-IV of FIG. 3B. It is noted that the flow paths downstream of the housing side flow paths 323 are formed symmetrically between the sensor module Sa side and the sensor module Sb side. Thus, in the following description, the exhaled air flow path on the sensor module Sa side (see FIG. 4) will be described, and the description of the flow path on the sensor module Sb side will be omitted.

As shown in FIG. 3A to FIG. 4, a cylindrical lower protrusion 325 (see FIG. 4) is integrally formed on the inner circumferential surface on the opposite side from the bottom surface 322a of the mounting hole 322 of the air inlet side housing 32. A restricted flow path 326 connected to the housing side flow path 323 is formed on the inner circumferential side of the lower protrusion 325, and the case 35 of the sensor modules Sa and Sb is mounted to the lower protrusion 325.

The case 35 includes the above-described cylinder portion 350, a bottom wall portion 351 extending from the cylinder portion 350 to one side in the axial direction (left side in FIG. 4) of the air inlet unit 3, and a side wall portion 352 and an end wall portion 353 rising from the bottom wall portion 351, and these portions 350 to 353 are integrally formed. On the inner circumferential side of the cylinder portion 350, a fitting hole 354 into which the lower protrusion 325 is fitted and a case side flow path 355 connected to the fitting hole 354 are formed.

The fitting hole 354 and the case side flow path 355 are each formed with a circular cross-section. By forming the inner diameter of the case side flow path 355 smaller than the inner diameter of the fitting hole 354, a step is formed on the inner circumferential side of the cylinder portion 350, and the lower protrusion 325 is fitted into this step portion.

In the state where the cylinder portion 350 is mounted to the lower protrusion 325, the housing side flow path 323, the restricted flow path 326, and the case side flow path 355 form a flow path that extends linearly in the radial direction (substantially parallel to the blowing direction of exhaled air into each air inlet 310 and 311).

The exhaled air blown into the upper air inlet 310 (see FIG. 3A and FIG. 3B) is exhausted from the first exhaust port 334 through the above-described bent flow paths 314a and 315a (for the first bent flow path 314a, see FIG. 3A and FIG. 3B), the housing side flow path 323, the restricted flow path 326, and the case side flow path 355. Hereinafter, these flow paths 314a, 315a, 323, 326, and 355 will be collectively referred to and described as the “main flow path” of exhaled air.

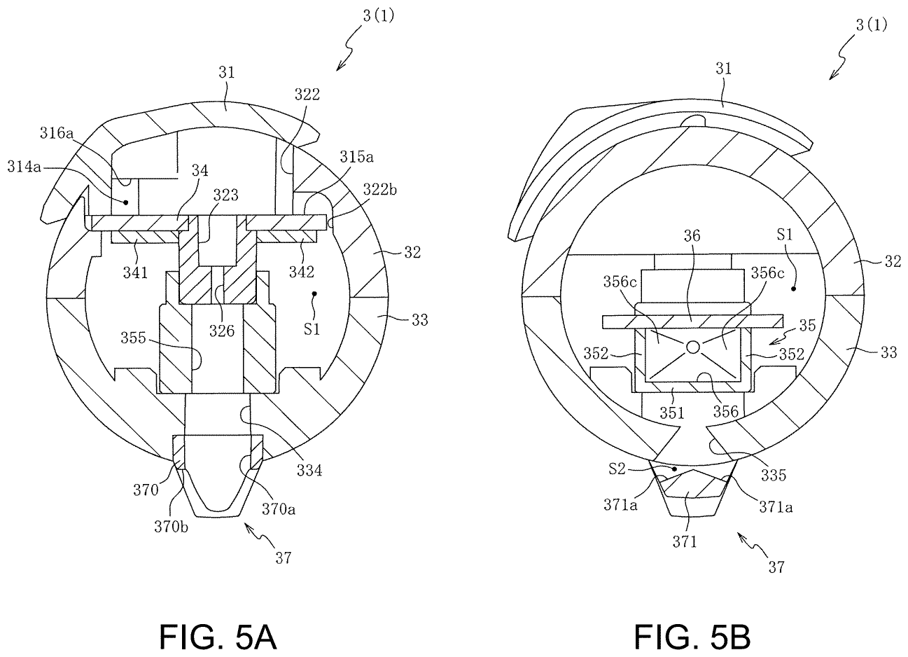

The bottom wall portion 351 of the case 35 is formed in a flat plate shape extending in the axial direction of the air inlet unit 3, and the side wall portions 352 are formed in a pair on two end sides in the width direction of the bottom wall portion 351 (perpendicular direction to the paper surface in FIG. 4) (see FIG. 5B). The end wall portion 353 is formed in a wall shape rising from the end portion in the axial direction of the bottom wall portion 351 (the end portion on the opposite side from the cylinder portion 350 side), and these wall portions 351 to 353 are formed in a box shape with one surface side (air inlet side housing 32 side) open. By closing this open part with the substrate 36, a branch flow path 356 surrounded by the substrate 36 and the wall portions 351 to 353 is formed inside the case 35.

The branch flow path 356 is a flow path extending in the axial direction of the air inlet unit 3, and in order to connect one end portion thereof to the main flow path (case side flow path 355), an opening 356a (first opening) of the branch flow path 356 is formed on the inner circumferential surface of the case side flow path 355. That is, the branch flow path 356 branches so as to intersect with the case side flow path 355. Further, the other end portion of the branch flow path 356 is connected to the outside of the case 35 through an opening 356b (second opening) formed in the end wall portion 353.

On the inner surface of the substrate 36 facing the branch flow path 356, a temperature sensor 360 and a heater 362 are provided arranged in the axial direction (longitudinal direction of the branch flow path 356). The temperature sensor 360 may use a known temperature sensor composed of a thermistor or the like, and the heater 362 may use a known heating element such as a chip resistor, so detailed description is omitted.

The air in the branch flow path 356 is heated by the heater 362, and the flow of the heated air (temperature change in the branch flow path 356) is detected by the temperature sensor 360. In the case of the case side flow path 355 side being the upstream side of the branch flow path 356, in this embodiment the temperature sensor 360 is disposed on the upstream side of the heater 362, but the temperature sensor 360 may be disposed on the downstream side of the heater 362. Further, the temperature sensor 360 and the heater 362 may be arranged side by side in the width direction (perpendicular direction to the paper surface in FIG. 4) orthogonal to the longitudinal direction of the branch flow path 356 (left-right direction in FIG. 4).

In the case of the flow rate (flow velocity) of exhaled air flowing in the main flow path (case side flow path 355) changing, changes also occur in the airflow in the branch flow path 356 (sub flow path branching from the main flow path), and changes in the airflow in this branch flow path 356 (temperature changes due to the flow of air heated by the heater 362) are detected by the temperature sensor 360. A musical sound signal based on the detection result of this temperature sensor 360 is generated by a sound source, and an electronic sound based on this musical sound signal is emitted from an amplifier, a speaker, or the like (neither of which is shown).

In order to accurately detect the flow rate of exhaled air flowing in the main flow path with the temperature sensor 360 based on such changes in airflow in the branch flow path 356, it is necessary to prevent saliva contained in the exhaled air and moisture generated by condensation of humidity contained in the exhaled air from remaining in the main flow path or the branch flow path 356. In particular, in a state where such moisture adheres to the temperature sensor 360, it becomes difficult to accurately detect the performer's exhaled air. A configuration that resolves these problems is described below.

The case side flow path 355 and the opening 356a of the branch flow path 356 are each formed with a circular cross-section, but the diameter of the opening 356a of the branch flow path 356 is formed smaller compared to the diameter of the case side flow path 355. That is, the cross-sectional area of the opening 356a of the branch flow path 356 is formed smaller compared to the cross-sectional area of the part (case side flow path 355) of the main flow path to which the opening 356a of the branch flow path 356 is connected. This provides an effect of making it difficult for exhaled air containing humidity to flow into the temperature sensor 360 side disposed in the branch flow path 356.

This may be attributed to the fact that since the opening 356a of the branch flow path 356 is formed relatively small, exhaled air passing through the case side flow path 355 becomes difficult to flow into the branch flow path 356 side. Further, as another factor, it is conceivable that negative pressure is generated in the branch flow path 356 by the exhaled air passing through the case side flow path 355, and the air in the branch flow path 356 is drawn from the opening 356a into the case side flow path 355 by that negative pressure.

By suppressing exhaled air containing humidity from flowing into the branch flow path 356 side, it is possible to suppress moisture generated by condensation or the like from adhering to the temperature sensor 360. Thus, the flow rate (flow velocity) of exhaled air flowing in the main flow path may be accurately detected by the temperature sensor 360 based on changes in airflow in the branch flow path 356.

Further, a cylindrical protrusion portion 357 whose tip end becomes the opening 356a of the branch flow path 356 is integrally formed on the inner circumferential surface of the case side flow path 355. By causing the opening 356a of the branch flow path 356 to protrude toward the inner circumferential side of the case side flow path 355 with this protrusion portion 357, it is considered that effects are obtained such that exhaled air containing humidity becomes difficult to flow into the branch flow path 356 side, and negative pressure becomes more likely to be generated in the branch flow path 356 by exhaled air passing through the main flow path.

Further, the tip end of the protrusion portion 357 (the edge of the opening 356a of the branch flow path 356) is disposed on an extension line of the flow path of the restricted flow path 326. That is, in a view of the inflow direction of exhaled air from the restricted flow path 326 to the case side flow path 355 (up-down direction view in FIG. 4), the restricted flow path 326 and the tip end of the protrusion portion 357 are disposed at overlapping positions. This is also considered to provide an effect that negative pressure becomes more likely to be generated in the branch flow path 356 by exhaled air passing through the main flow path.

Thus, this embodiment has a structure in which exhaled air flowing into the branch flow path 356 from the opening 356a having a relatively small cross-sectional area is detected by the temperature sensor 360, or a structure in which negative pressure is generated in the branch flow path 356 by exhaled air passing through the case side flow path 355, and the airflow in the branch flow path 356 generated by that negative pressure is detected by the temperature sensor 360. In the case of such a structure, changes in airflow in the branch flow path 356 become relatively small. Here, with a configuration that detects temperature changes of air in the branch flow path 356 heated by the heater 362 with the temperature sensor 360 as in this embodiment, slight changes in airflow in the branch flow path 356 may be detected by the temperature sensor 360. Thus, the flow rate of exhaled air flowing in the main flow path may be detected with high accuracy.

Further, since the sensor modules Sa and Sb are arranged in the axial direction with the cylinder portions 350 facing each other (see FIG. 2), and the branch flow path 356 is formed along the axial direction (longitudinal direction) of the air inlet unit 3, the branch flow path 356 for sensing exhaled air may be formed long. This enables each cylinder portion 350 to be positioned close to the lip plate 31 and the air inlet unit 3 to simulate the appearance of an elongated flute (head joint), while allowing changes in airflow within the branch flow path 356 to be accurately detected by the temperature sensor 360.

Further, in this embodiment, exhaled air blown into the upper air inlet 310 and exhaled air blown into the lower air inlet 311 are detected by separate sensor modules Sa and Sb (see FIG. 2). That is, instead of forming two branch flow paths 356 in one case 35, the configuration uses two cases 35 as separate components (making the cases 35 compact) to individually form branch flow paths 356, so the shape of the branch flow paths 356 may be formed with high accuracy.

Thus, airflow in the branch flow paths 356 may be accurately detected by the temperature sensors 360.

Thus, in this embodiment, exhaled air is detected based on airflow in the branch flow path 356, and a tapered surface 356c for stabilizing this airflow is formed in the branch flow path 356. The tapered surface 356c is an inclined surface connected to one end (the end portion on the opening 356a side) of the inner surface of the bottom wall portion 351 or side wall portion 352 of the case 35 (regarding the point where the tapered surface 356c is connected to the side wall portion 352, see FIG. 5B). By forming such a tapered surface 356c, the cross-sectional area of the branch flow path 356 may be gradually reduced toward the opening 356a side. This may suppress the occurrence of irregular airflow (turbulent flow) within the branch flow path 356, so the flow rate of exhaled air flowing in the main flow path may be accurately detected by the temperature sensor 360.

Further, a ventilation opening 333c is formed on the side surface of the boss 333 that faces the end wall portion 353 of the case 35, and the recess portion 333b formed on the outer circumferential surface of the exhaust side housing 33 by the boss 333 is connected to the opening 356b of the branch flow path 356 via the ventilation opening 333c. This enables ventilation of the interior of the branch flow path 356 by airflow passing through the ventilation opening 333c and the opening 356b, so condensation on the temperature sensor 360 may be suppressed.

Further, by utilizing the boss 333 (recess portion 333b) for fixing the sensor modules Sa and Sb to ventilate the branch flow path 356, it becomes unnecessary to separately provide holes or indentations in the exhaust side housing 33 for performing such ventilation. Thus, the number of holes and indentations formed in the exhaust side housing 33 may be reduced, so the appearance of the electronic wind instrument 1 may be improved.

Here, for example, in the case of a performer taking a breath during performance, air may be drawn in from the upper air inlet 310 (see FIG. 3A and FIG. 3B). Further, for example, in the case of a performer performing an action with their mouth separated from the upper air inlet 310, outside air may flow in from the upper air inlet 310 due to the accompanying movement of the electronic wind instrument 1. In response to the temperature sensor 360 detecting airflow accompanying such intake air or inflow of outside air, a problem arises where musical sounds unintended by the performer are generated.

Further, in the case of a performer strongly blowing exhaled air into the upper air inlet 310, the flow rate of that exhaled air may exceed the measurable range of the temperature sensor 360. Outside such measurement range of the temperature sensor 360, even if the flow rate of exhaled air is changed, no change occurs in the generated musical sound, so a problem arises where musical sounds intended by the performer become difficult to generate.

In contrast, in this embodiment, as described above, the lip plate 31 is formed with the first bent flow path 314a (see FIG. 3A and FIG. 3B) that extends in a direction orthogonal to the blowing direction of exhaled air into the upper air inlet 310 (in this embodiment, in the axial direction of the air inlet unit 3). Furthermore, the second bent flow path 315a connected to the downstream side of the first bent flow path 314a extends in a direction that further bends from the connection portion (in this embodiment, a direction orthogonal to both the blowing direction of exhaled air and the axial direction of the air inlet unit 3).

By forming such bent flow paths on the upstream side of the main flow path, compared to a case where the upper air inlet 310 and the housing side flow path 323 are connected in a straight line, for example, even if the above-mentioned intake air by the performer or inflow of outside air occurs, generation of accompanying airflow in the case side flow path 355 may be suppressed.

Further, at the boundary parts of these bent flow paths 314a and 315a, a restricted flow path 316a (see FIG. 3A) having a smaller flow path cross-sectional area than each of the bent flow paths 314a and 315a is formed. Furthermore, a restricted flow path 326 having a smaller flow path cross-sectional area than each of those flow paths 323 and 355 is also formed between the housing side flow path 323 and the case side flow path 355. By providing such restricted parts where the cross-sectional area of the main flow path is partially reduced in the middle of the main flow path (upstream side of the connection portion of the branch flow path 356), generation of airflow accompanying the above-mentioned intake air by the performer or inflow of outside air in the case side flow path 355 may also be suppressed.

By suppressing generation of airflow accompanying intake air by the performer or inflow of outside air in the case side flow path 355, erroneous detection of that airflow by the temperature sensor 360 may be suppressed. Thus, generation of musical sounds unintended by the performer may be suppressed.

Further, by adjusting the flow path length of each bent flow path 314a and 315a, or by adjusting the flow path cross-sectional area of the restricted flow paths 316a and 326, it is possible to suppress exhaled air that the performer strongly blows into the upper air inlet 310 from exceeding the measurable range of the temperature sensor 360. Thus, musical sounds intended by the performer become easier to generate.

In this way, by providing bent parts and restricted parts in the main flow path, musical sounds intended by the performer become easier to generate. However, if the path of the main flow path is formed in a complex manner, saliva contained in exhaled air and moisture generated by condensation tend to remain in the main flow path. If this moisture blocks, for example, the restricted flow path 326 or the opening 356a of the branch flow path 356, it becomes difficult to detect exhaled air blown from each air inlet 310 and 311 with the temperature sensor 360.

Thus, in this embodiment, a configuration is adopted in which moisture is dried by heating the part on the upstream side of the main flow path with the substrate 34. Furthermore, this configuration also provides an effect of preventing condensation from occurring in the main flow path. This effect of preventing condensation from occurring means preventing water vapor contained in air from liquefying, which is a different action from drying moisture. That is, since the saturated water vapor amount (mass of water vapor that can exist in a unit volume of air) becomes larger as the temperature is higher, heating the part on the upstream side of the main flow path may not only dry moisture but also prevent condensation from occurring. This configuration will be described with reference to FIG. 4 to FIG. 5B.

FIG. 5A is a cross-sectional view of the air inlet unit 3 taken along line Va-Va of FIG. 4, and FIG. 5B is a cross-sectional view of the air inlet unit 3 taken along line Vb-Vb of FIG. 4.

As shown in FIG. 4 to FIG. 5B, the substrate 34 is provided with a heater 341 and a sensor 342 (both refer to FIG. 5A). The heater 341 may use a known heating element such as a chip resistor, and the sensor 342 may use a known temperature sensor composed of a thermistor or the like, so detailed description is omitted.

The temperature of the substrate 34 accompanying heating by the heater 341 is detected by the sensor 342, and is controlled so that the heater 341 repeats on/off (or the temperature of the heater 341 changes) based on the detection result of the sensor 342. Through control over this heater 341, the temperature of the substrate 34 is maintained at around 30° C. to 35° C.

By heating the substrate 34 that constitutes the bottom surface of each bent flow path 314a and 315a with the heater 341, saliva adhering to each bent flow path 314a and 315a may be dried and moisture due to condensation in each bent flow path 314a and 315a may be suppressed from occurring.

Further, by heating the substrate 34 with the heater 341, the housing side flow path 323 connected to the second bent flow path 315a and the restricted flow path 326 positioned on the downstream side of the housing side flow path 323 may also be heated. Thus, saliva adhering to the housing side flow path 323 and the restricted flow path 326 may be dried, and moisture due to condensation may be suppressed from occurring in the housing side flow path 323 and the restricted flow path 326.

By suppressing moisture from remaining in the restricted flow path 326 and in the main flow path upstream of the opening 356a of the branch flow path 356 (see FIG. 4), the moisture may be suppressed from flowing down to the downstream side of the main flow path together with exhaled air. This may suppress the restricted flow path 326 and the opening 356a of the branch flow path 356 from being blocked by moisture, so exhaled air flowing in the main flow path may be accurately detected by the temperature sensor 360 (see FIG. 4).

Here, in this embodiment, exhaled air flowing in the main flow path is mainly exhausted from the first exhaust port 334, but a portion of the exhaled air is configured to be introduced into the internal space S1 of each housing 32 and 33 through the leak flow path 322b (see FIG. 5A).

More specifically, the housing side flow path 323 opens in the middle of the second bent flow path 315a, and in the mounting hole 322 where the lip plate 31 is mounted, a leak flow path 322b (see FIG. 5A) is formed that connects the end portion on the downstream side of the second bent flow path 315a to the internal space S1 side of each housing 32 and 33. This leak flow path 322b is formed by a gap between the edge of the substrate 34 in the circumferential direction of the air inlet side housing 32 and the inner circumferential surface of the air inlet side housing 32.

By forming such a leak flow path 322b that branches from the main flow path, a portion of the airflow generated in the second bent flow path 315a may be introduced to the internal space S1 side of the air inlet unit 3 (i.e., a portion of the airflow may be discharged to the outside of the main flow path). This may suppress the generation of airflow in the case side flow path 355 due to the performer's inhalation or inflow of outside air as described above, so erroneous detection of such airflow by the temperature sensor 360 (see FIG. 4) may be suppressed. Thus, generation of musical sounds unintended by the performer may be suppressed.

Further, by adjusting the flow path cross-sectional area of the leak flow path 322b, it is possible to suppress exhaled air that the performer strongly blows into the upper air inlet 310 from exceeding the measurable range of the temperature sensor 360. Thus, musical sounds intended by the performer become easier to generate.

Exhaled air that flows into the internal space S1 side of each housing 32 and 33 from the leak flow path 322b is exhausted from the second exhaust port 335 (see FIG. 5B) that penetrates the exhaust side housing 33. The second covering portion 371 of the decorative body 37 that covers the second exhaust port 335 is formed to be bridged between the first covering portion 370 and the third covering portion 372 (to extend in the axial direction) (see FIG. 4), and a cavity S2 (see FIG. 5B) is formed between the exhaust side housing 33 (second exhaust port 335) and the second covering portion 371.

This may suppress the second exhaust port 335 from being blocked by the placement surface even in the case of the electronic wind instrument 1 being placed on a table or the like, and ventilation through the cavity S2 and the second exhaust port 335 may be ensured. Thus, even with a structure that leaks a portion of exhaled air to the internal space S1 of each housing 32 and 33 through the leak flow path 322b (see FIG. 5A), condensation on components of each housing 32 and 33 (e.g., the substrate 36 shown in FIG. 5B) may be suppressed.

Further, on the inner circumferential surface of the second covering portion 371 that faces the second exhaust port 335, a pair of inclined surfaces 371a (see FIG. 5B) arranged side by side in the circumferential direction are formed. The pair of inclined surfaces 371a are flat surfaces that incline away from the exhaust side housing 33 (second exhaust port 335) from the apex at the center side in the circumferential direction (ridge line where they intersect each other) toward the end portions on the outer side in the circumferential direction. By forming such mountain-shaped inclined surfaces 371a, the flow velocity of air passing through the cavity S2 along the circumferential direction (left-right direction in FIG. 5B) rises due to the inclined surfaces 371a. This rise in the flow velocity of air generates negative pressure in the internal space S1 of each housing 32 and 33, and the negative pressure may exhaust air in the internal space S1 from the second exhaust port 335 to the outside.

Further, since the opening dimension of the second exhaust port 335 in the circumferential direction gradually increases from the internal space S1 toward the outer circumferential surface of the exhaust side housing 33, air in the internal space S1 is easily exhausted from the second exhaust port 335 to the outside by the airflow passing through the cavity S2 as described above. This may suppress condensation on components of each housing 32 and 33 even with a structure that leaks a portion of exhaled air to the internal space S1 of each housing 32 and 33 through the leak flow path 322b (see FIG. 5A).

Further, as described above, through holes 370a and 372a (for the through hole 372a, see FIG. 4) are formed in each covering portion 370 and 372 of the decorative body 37 that covers the first exhaust port 334 and the recess portion 333b (ventilation opening 333c) of the boss 333 (see FIG. 4). For example, a depression 370b is formed at the edges on two sides in the circumferential direction of the through hole 370a. Further, a similar depression 372b is formed at the edges of the through hole 372a shown in FIG. 4.

By forming such depressions 370b and 372b in the through holes 370a and 372a, the first exhaust port 334 and the recess portion 333b (ventilation opening 333c) may be suppressed from being blocked by the placement surface even in the case of the electronic wind instrument 1 being placed on a table or the like. Thus, ventilation through the first exhaust port 334 and the recess portion 333b (ventilation opening 333c) may be ensured.

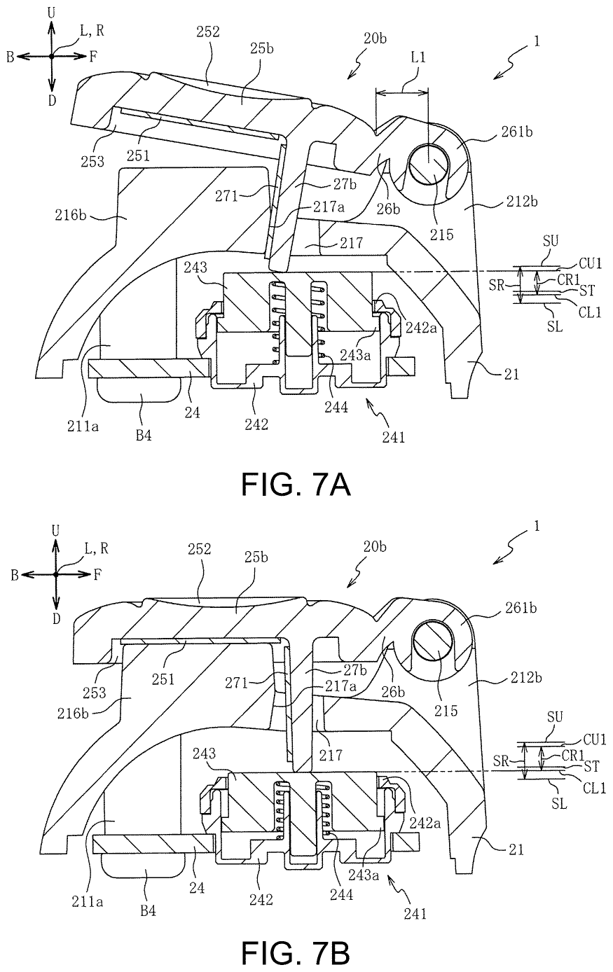

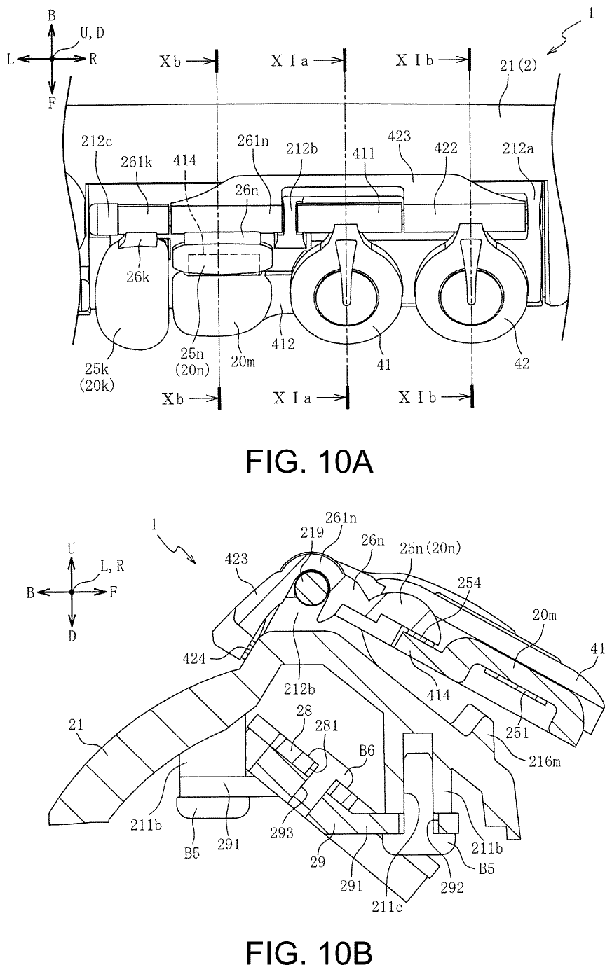

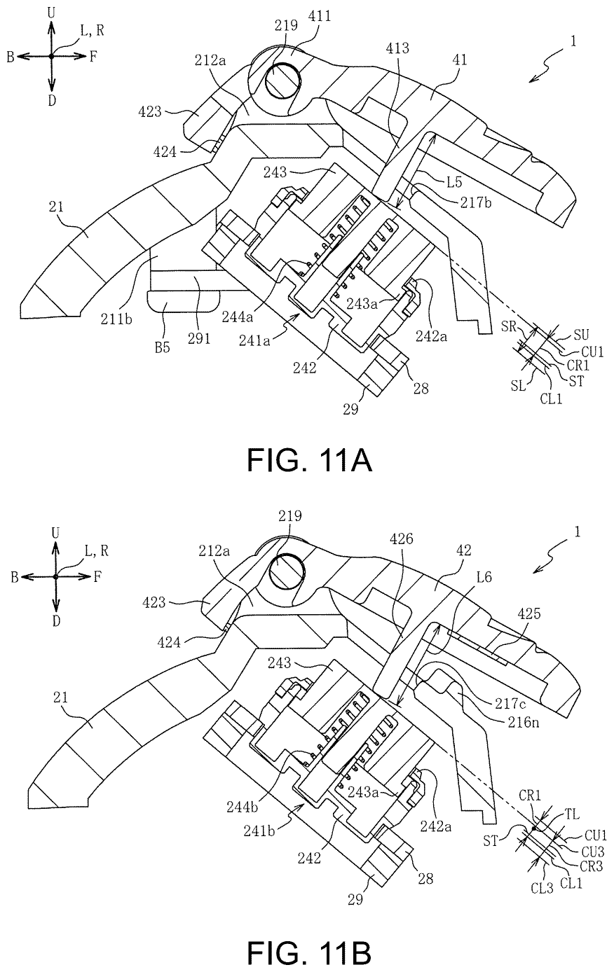

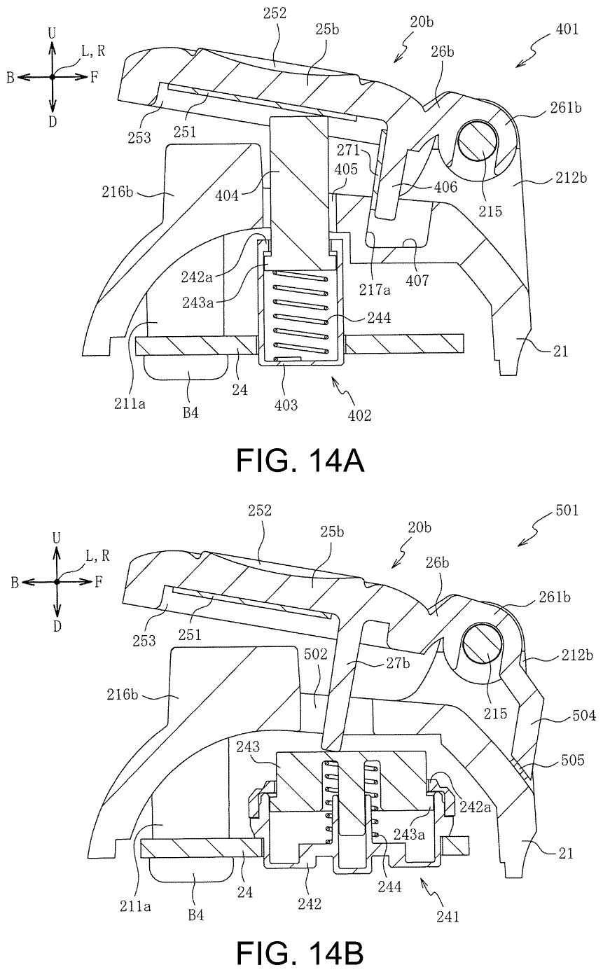

Next, the structure of the electronic wind instrument 1 at positions where the operators 20a to 20j are mounted will be described with reference to FIG. 6. FIG. 6 is a partially enlarged perspective view of the electronic wind instrument 1 showing a state where the instrument body 2 is disassembled and the operators 20a to 20j are removed. The arrow U-D direction, F-B direction, and L-R direction in FIG. 6 respectively show the up-down direction, front-back direction, and left-right direction (axial direction) of the electronic wind instrument 1, and the same applies to FIG. 7A and subsequent drawings. Further, in FIG. 6, illustration of each portion (lower housing 22, etc.) of the instrument body 2 arranged below (arrow D side) a substrate 24 is omitted, and the same applies to FIG. 7A to FIG. 9A, FIG. 10B to FIG. 11B, FIG. 14A, and FIG. 14B.

The portion of the instrument body 2 where the operators 20a to 20j are mounted is a portion corresponding to the body tube of a flute. The substrate 24 is arranged on the inner circumferential side of the upper housing 21 at this portion. Multiple through holes 24a (six in this embodiment) for passing bolts B4 are formed in the substrate 24. Bolt holes (not shown) are formed at the lower ends of multiple bosses 211a (see FIG. 7A) that protrude downward from the inner circumferential surface of the upper housing 21. The substrate 24 is fixed to the upper housing 21 by screwing the multiple bolts B4 passing through the through holes 24a into these bolt holes.

The substrate 24 is provided with ten switches (detection portions) 241 that individually detect the operation states of the ten operators 20a to 20j. These ten switches 241 are all configured identically and are aligned on a straight line parallel to the axial direction of the upper housing 21 so as to be respectively positioned directly below the operators 20a to 20j.

From the front side (arrow F side) of the outer circumferential surface of the upper housing 21, support portions 212a, 212b, and 212c rise upward (arrow U direction), and these are arranged on a straight line parallel to the axial direction. Multiple support portions 212b (four in this embodiment) are arranged between the leftmost support portion 212a (arrow L side) and the rightmost support portion 212c (arrow R side).

Through holes 213 penetrating in the axial direction are respectively formed at the upper ends of the support portions 212a and 212b. A bolt hole 214 opening toward the support portion 212b side is formed at the upper end of the support portion 212c. By inserting a shaft 215 into the multiple through holes 213 from the support portion 212a side and screwing a screw portion 215a provided at one end of the shaft 215 into the bolt hole 214, one shaft 215 is mounted on the outer circumferential side of the upper housing 21 so as to be bridged across the multiple support portions 212a to 212c. The shaft 215 mounted in this manner is arranged on a straight line parallel to the axial direction of the upper housing 21.

Each of the operators 20a to 20j is rotatably supported around the shaft 215 arranged on this straight line, and the operators 20a to 20j are arranged side by side from the left side to the right side in the order of operators 20a to 20j. Since the performer operates multiple operators such as keys arranged side by side in the axial direction of a flute as well, such rotational support may bring the operation feel of the operators 20a to 20j close to the operation feel of a flute.

Each of the operators 20a to 20j includes an operation portion 25a to 25j that the performer directly touches and operates, a connection portion 26a to 26j that connects the operation portion 25a to 25j to the shaft 215, and an actuator 27a to 27j that protrudes downward from the operation portion 25a to 25j or the connection portion 26a to 26j, and is integrally formed using a resin material. Each of the actuators 27a to 27j is a plate-shaped portion for transmitting the operation of each of the operators 20a to 20j to the switch 241 directly below itself by coming into contact with the switch 241 through a through hole 217 provided in the upper housing 21. It is noted that the through hole 217 is formed by making a recess portion that recesses the outer surface of the upper housing 21 toward the interior of the upper housing 21 communicate with the interior of the upper housing 21.

The operation portions 25a, 25b, 25f, 25h, and 25j of the first lid operators 20a, 20b, 20f, 20h, and 20j, and the operation portion 25c of the second lid operator 20c are respectively formed in a disc shape. The first lid operators 20a, 20b, 20f, 20h, and 20j and the second lid operator 20c imitate keys integrated with lids that open and close tone holes in a flute.

In an up-down direction view, the centers of the operation portions 25a, 25b, 25f, 25h, and 25j are aligned on a straight line parallel to the axial direction of the upper housing 21, and the center of the operation portion 25c is arranged to be shifted toward the back side (arrow B side) in the circumferential direction relative to these. This shift of the center is the main difference between the first lid operators 20a, 20b, 20f, 20h, and 20j and the second lid operator 20c, and this shift imitates the key arrangement of an offset key type flute.

In contrast to these, the operation portion 25d of the first lever operator 20d is not formed in a disc shape like the operation portion 25a, etc., but is formed in a rod shape (lever shape) extending in the axial direction of the upper housing 21. Similarly, the operation portions 25e, 25g, and 25i of the second lever operators 20e, 20g, and 20i are formed in a rod shape (lever shape) extending in the circumferential direction. The first lever operator 20d and the second lever operators 20e, 20g, and 20i imitate levers for opening and closing lids at distant positions through an interlocking mechanism in a flute.

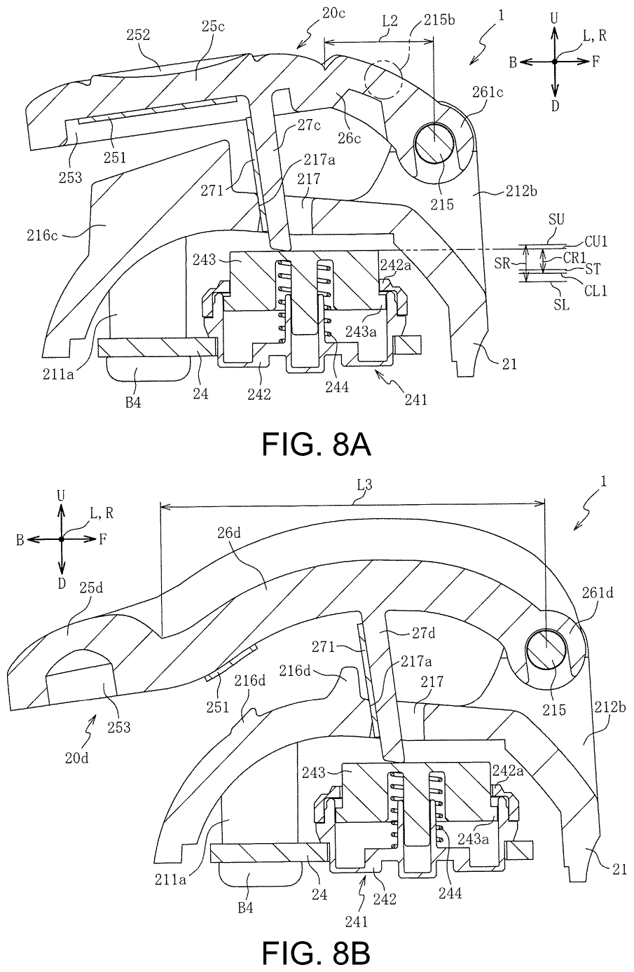

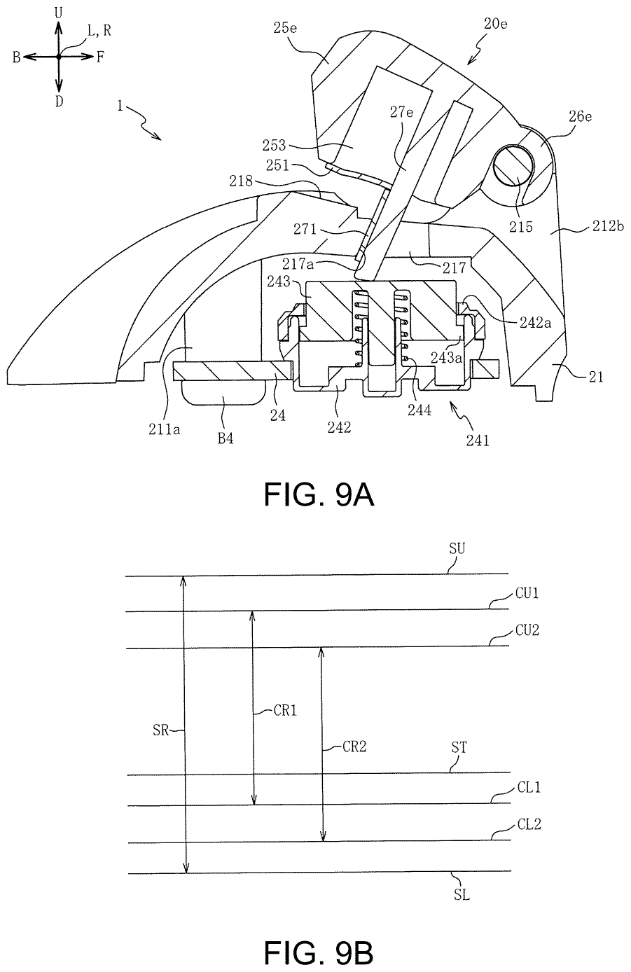

First, the first lid operators 20a, 20b, 20f, 20h, and 20j will be described with reference to FIG. 7A and FIG. 7B in addition to FIG. 6. FIG. 7A is a cross-sectional view of the electronic wind instrument 1 at a position including the first lid operator 20b in a non-pressed state. FIG. 7B is a cross-sectional view of the electronic wind instrument 1 at a position including the first lid operator 20b in a pressed state. In FIG. 7A and FIG. 7B, a cross-section cut along a plane orthogonal to the axial direction of the electronic wind instrument 1 is illustrated, and illustration of a portion of the configuration on the far side from the cross-section is omitted. The same applies to FIG. 8A, FIG. 8B, and FIG. 9A.

The operation portions 25b, 25f, 25h, and 25j are all formed in a disc shape with the same outer diameter, and the outer diameter of the operation portion 25a is smaller than these. Due to this difference in outer diameter, the length of the connection portion 26a that connects the operation portion 25a and the shaft 215 becomes longer than a length L1 of the connection portions 26b, 26f, 26h, and 26j that connect the operation portions 25b, 25f, 25h, and 25j and the shaft 215. Since the first lid operators 20a, 20b, 20f, 20h, and 20j and the surrounding upper housing 21, etc. are configured substantially identically in other respects, the first lid operator 20b and the area around shown in FIG. 7A and FIG. 7B will be mainly described, and part of other descriptions will be omitted.

The connection portion 26b of the first lid operator 20b is formed in an arm shape extending in the circumferential direction (front-back direction) of the upper housing 21. The operation portion 25b is connected to the tip end (back end) in the circumferential direction of the connection portion 26b. The base end (front end) in the circumferential direction of the connection portion 26b is formed by a cylindrical portion 261b having a cylindrical shape. By inserting the shaft 215 to the inner circumferential side of this cylindrical portion 261b, the first lid operator 20b is rotatably mounted to the upper housing 21. The first lid operators 20a, 20f, 20h, and 20j respectively include cylindrical portions 261a, 261f, 261h, and 261j that are substantially identical to this cylindrical portion 261b.

From the outer circumferential surface of the upper housing 21 on the lower side of the first lid operator 20b, a substantially columnar protruding portion 216b that imitates a tone hole of a flute protrudes upward toward the operation portion 25b. The operation portion 25b that is pressed by the performer and rotates downward (in a pressing direction approaching the upper housing 21) comes into contact with the upper end of the protruding portion 216b, whereby the downward rotation thereof is restricted. That is, the protruding portion 216b constitutes a pressing-side stopper that restricts this downward rotation. As portions substantially identical to the protruding portion 216b, protruding portions 216a, 216f, 216h, and 216j respectively protrude from the outer circumferential surface of the upper housing 21 toward the operation portions 25a, 25f, 25h, and 25j.

It is noted that a cushion 251 composed of an elastic member such as rubber or sponge is mounted to the lower surface of a resin portion of the operation portion 25b at a position where the upper end of the protruding portion 216b comes into contact. This enables the cushion 251 to suppress impact sound and vibration at the time when the operation portion 25b comes into contact with the upper end of the protruding portion 216b.

An actuator 27b protrudes substantially vertically from the lower surface of the operation portion 25b on the front side (shaft 215 side) with respect to this cushion 251, and passes through the through hole 217 of the upper housing 21. In the case of attempting to rotate the first lid operator 20b, which has been pressed downward by the performer, upward (return direction) away from the upper housing 21 in a direction to return the first lid operator 20b, the actuator 27b comes into contact with a wall surface 217a on the back side of the through hole 217, and the rotation thereof is restricted. In this way, the actuator 27b also serves as a return-side stopper that restricts an upward rotation. Therefore, compared to a case where the actuator 27b and the return-side stopper are provided separately (for example, the fifth embodiment of FIG. 14B), the structures of these may be simplified and the number of parts may be reduced.

Here, for example, in the related art described in FIG. 1 of Japanese Patent Application Laid-Open No. H1-243097, a return-side stopper is provided at the tip end of an arm extending from the connection portion of the operator to the opposite side from the operation portion, and the upward rotation of the operator is restricted by bringing this return-side stopper into contact with the outer circumferential surface of the housing. In this case, there is a possibility that the return-side stopper may complicate the appearance of the electronic wind instrument and make it difficult to miniaturize the electronic wind instrument.

In contrast, in this embodiment, the return-side stopper (actuator 27b) protrudes from the first lid operator 20b toward the upper housing 21 side, and is inserted into the through hole 217 of the upper housing 21 to come into contact with the wall surface 217a of the through hole 217. In this way, the return-side stopper restricts a rotation by utilizing the inner side with respect to the outer circumferential surface of the upper housing 21, so the appearance of the electronic wind instrument 1 may be simplified and the electronic wind instrument 1 may be easily miniaturized.

It is noted that a cushion 271 composed of an elastic member is mounted to the wall surface 217a side of the resin portion of the actuator 27b. This enables the cushion 271 to suppress impact sound and vibration at the time when the actuator 27b comes into contact with the wall surface 217a.

The through hole 217 directly below the first lid operator 20b is formed by removing a portion on the front side of the cylindrical protruding portion 216b to penetrate through the upper housing 21 at the removed position. Correspondingly, the actuator 27b protrudes from the front side of the operation portion 25b. Therefore, the actuator 27b is hidden by the protruding portion 216b and becomes difficult to see, so the appearance around the first lid operator 20b may be brought close to the appearance of a flute that does not have components corresponding to the actuator 27b.

The disc-shaped operation portion 25b to which the actuator 27b is connected imitates a key integrated with a lid in a flute, and therefore is formed so that the upper surface and lower surface are partially recessed in the same manner as that key. It is noted that a recess 252 on the upper surface is curved to conform to a finger of the performer and is for making the operation portion 25b easy to operate. Further, a recess 253 on the lower surface is for covering the upper end side of the protruding portion 216b with the operation portion 25b in the pressed state shown in FIG. 7B, and also serves as a lightening portion for the operation portion 25b.

To mold the operation portion 25b having these recesses 252 and 253 with a mold, it is required to divide the mold in the plate thickness direction of the operation portion 25b. Since the actuator 27b protrudes from the operation portion 25b in this plate thickness direction, no undercut portion is formed due to provision of the actuator 27b, and the operation portion 25b and the actuator 27b may be integrally molded with resin using the mold.

The performer rotates the first lid operator 20b by pressing the operation portion 25b in this plate thickness direction. In other words, since the operation portion 25b is formed in a plate shape that expands in each direction perpendicular to the direction in which the operation portion 25b is pressed, the finger of the performer may be easily brought into contact with the operation portion 25b during pressing, and the first lid operator 20b may be easily operated. Furthermore, since the actuator 27b protrudes from the operation portion 25b in the plate thickness direction in which the operation portion 25b is pressed by the performer, the force pressed by the performer may be easily transmitted from the actuator 27b to the switch 241.

The switch 241 includes a body portion 242 that is fixed to the substrate 24, a movable portion 243 that moves in the up-down direction (plate thickness direction of the substrate 24) and appears and disappears from the body portion 242, and an elastic body 244 that is compressed in the up-down direction therebetween. The body portion 242 is formed in a box shape with a closed lower surface and an open upper surface, and an edge portion 242a on the upper side of the opening extends toward the inner side.

The upper end side of the movable portion 243 protrudes upward from the body portion 242 through the opening on the inner side of the edge portion 242a, and the tip end (lower end) of the actuator 27b is in contact with the upper end of the movable portion 243. A flange 243a that opposes the edge portion 242a in the up-down direction extends from the movable portion 243 inside the body portion 242. The position where this flange 243a and the edge portion 242a come into contact with each other is an upper limit position SU of a movable range SR of the movable portion 243. On the other hand, the position where the movable portion 243 comes into contact with the bottom inside the body portion 242 is a lower limit position SL of the movable range SR of the movable portion 243. The elastic body 244 is, for example, a coil spring, and generates a repulsive force so that the movable portion 243 moves toward this upper limit position SU.

In the case of the first lid operator 20b being operated downward by the performer from the non-pressed state shown in FIG. 7A, as shown in FIG. 7B, a downward force is transmitted from the actuator 27b to the movable portion 243, and the movable portion 243 is pressed against the repulsive force of the elastic body 244. The switch 241 acquires the pressed state (on state) of the first lid operator 20b by connecting contacts (not shown) in the case of this pressing amount (movement amount) becoming equal to or greater than a threshold value ST, and acquires the non-pressed state (off state) by separating the contacts in the case of this pressing amount being less than the threshold.

In the lower right of FIG. 7A and FIG. 7B, the height of the upper end of the movable portion 243 respectively in the case of the pressing amount becoming the threshold value ST, at the upper limit position SU and the lower limit position SL of the movable range SR of the movable portion 243, and at a return-side restriction position CU1 and a pressing-side restriction position CL1 of a rotation range CR1 of the first lid operator 20b is schematically illustrated. The same applies to FIG. 8A and FIG. 9B.

It is noted that the return-side restriction position CU1 shown in the lower right of FIG. 7A and FIG. 7B is the height of the upper end of the movable portion 243 at the position where the actuator (return-side stopper) 27b and the wall surface 217a come into contact with each other. Similarly, the pressing-side restriction position CL1 is the height of the upper end of the movable portion 243 at the position where the operation portion 25b comes into contact with the upper end of the protruding portion (pressing-side stopper) 216b. The return-side restriction position CU1 and the pressing-side restriction position CL1 are determined according to the position of the first lid operator 20b and the length (position of the tip end) of the actuator 27b. Further, in this embodiment, with the return-side restriction position CU1 as 0 degrees, the rotation range CR1 of the first lid operator 20b to the pressing-side restriction position CL1 is set to approximately 10 degrees. However, this rotation range CR1 may be smaller or larger than 10 degrees.

The threshold value ST of the pressing amount is set above the pressing-side restriction position CL1. This is to suppress the switch 241 from becoming unable to acquire the pressed state of the first lid operator 20b due to manufacturing errors of each portion, even though the first lid operator 20b has been rotated to the pressing-side restriction position CL1 shown in FIG. 7B.

It is noted that, in a flute, the pitch changes in the case of a key (operator) integrated with a lid that opens and closes a tone hole being pressed and the tone hole being blocked. To imitate the timing of this change with the electronic wind instrument 1, it is preferable to bring the threshold value ST as close as possible to the pressing-side restriction position CL1. In this embodiment, the threshold value ST of the pressing amount is at a position where the first lid operator 20b is rotated approximately 9 degrees from the return-side restriction position CU1, and the pressing-side restriction position CL1 is at a position of approximately 10 degrees. However, the position of the threshold value ST of the pressing amount is not limited to approximately 9 degrees, and is preferably 7 degrees to 9.5 degrees. This enables the pitch to be changed at substantially the same position as the pressing-side restriction position CL1. Therefore, the operation feel of the first lid operator 20b may be brought close to the operation feel of a flute.

Since the pressing-side restriction position CL1 is above the lower limit position SL, it is possible to prevent the force of the performer pressing the first lid operator 20b from being directly transmitted from the movable portion 243 to the body portion 242 or the substrate 24. This may suppress deformation or damage of the switch 241 and the substrate 24 due to that force, and may protect the switch 241 and the substrate 24.

In the case of the performer releasing the first lid operator 20b from pressing, the first lid operator 20b rotates so as to be lifted upward by the repulsive force of the elastic body 244, and returns to the non-pressed state and the return-side restriction position CU1 shown in FIG. 7A. Since the return-side restriction position CU1 is below the upper limit position SU, the repulsive force of the elastic body 244 is constantly applied to the actuator 27b at the return-side restriction position CU1, and the actuator 27b is pressed against the wall surface 217a of the through hole 217. This enables the first lid operator 20b to the movable portion 243 to be maintained in a basically constantly contacted state, so that differences in pressing feel (reaction force) caused by spanning contact/non-contact of some of those components may be less likely to occur.

In a flute, there is no need to press a switch with an operator such as a key, so such differences in pressing feel caused by spanning contact/non-contact do not occur in the first place. By making differences in pressing feel less likely to occur as described above, the operation feel of the first lid operator 20b may be brought close to the operation feel of a flute. Furthermore, by maintaining contact from the first lid operator 20b to the movable portion 243, rattling of the first lid operator 20b may be suppressed.

Next, the second lid operator 20c will be described with reference to FIG. 8A. FIG. 8A is a cross-sectional view of the electronic wind instrument 1 at a position including the second lid operator 20c in a non-pressed state. It is noted that, since the second lid operator 20c and the area around are basically configured similarly to the first lid operator 20b and the area around, those similar portions will be roughly described, and part of the description will be omitted.

The operation portion 25c of the second lid operator 20c shown in FIG. 8A is formed in a disc shape with the same outer diameter as the operation portion 25b of the first lid operator 20b shown in FIG. 7A. An actuator 27c protrudes substantially vertically from the lower surface of this operation portion 25c, and a cushion 271 is provided on the wall surface 217a side of the actuator 27c. From the outer circumferential surface of the upper housing 21 on the lower side of the second lid operator 20c, a protruding portion 216c that constitutes a pressing-side stopper protrudes upward toward the operation portion 25c, similarly to the protruding portion 216b on the lower side of the first lid operator 20b.

A connection portion 26c of the second lid operator 20c is an arm-shaped portion where the tip end is connected to the operation portion 25c and the base end is formed by a cylindrical portion 261c having a cylindrical shape, similarly to the connection portion 26b of the first lid operator 20b. By inserting the shaft 215 into the inner circumferential side of this cylindrical portion 261c, the second lid operator 20c is rotatably mounted to the upper housing 21.

Similarly to the first lid operator 20b, the second lid operator 20c is operated by the performer within the rotation range CR1 from the return-side restriction position CU1 where the actuator (return-side stopper) 27c comes into contact with the wall surface 217a of the through hole 217, to the pressing-side restriction position CL1 where the operation portion 25c comes into contact with the upper end of the protruding portion (pressing-side stopper) 216c. The relationship between the height of the upper end of the movable portion 243 respectively at the return-side restriction position CU1 and the pressing-side restriction position CL1 of the second lid operator 20c, and the upper limit position SU and the lower limit position SL of the movable range SR of the switch 241 and the threshold value ST of the pressing amount is also similar to the relationship described for the first lid operator 20b.

Next, the portions that differ between the second lid operator 20c and the first lid operator 20b will be described. The second lid operator 20c has the center of the operation portion 25c shifted to the back side in the circumferential direction relative to the center of the operation portion 25b of the first lid operator 20b in order to imitate the key arrangement of an offset key type flute as described above.

A length L2 of the connection portion 26c of the second lid operator 20c is formed longer than the length L1 of the connection portion 26b of the first lid operator 20b by approximately the same amount as the shift amount between the center of the operation portion 25b and the center of the operation portion 25c in the circumferential direction. These lengths L1 and L2 are dimensions in the circumferential direction (more specifically, the left-right direction) from the axis center of the shaft 215 to the operation portions 25b and 25c in a non-pressed state. By setting the lengths L1 and L2 different in this manner, even though the operation portion 25b and the operation portion 25c are shifted in the circumferential direction, the shaft 215 that respectively rotatably supports the first lid operator 20b and the second lid operator 20c may be arranged on a straight line.

Here, an offset key type flute will be described using the names of portions of the corresponding electronic wind instrument 1. In the flute, another shaft 215b is provided at a position shifted in the circumferential direction by approximately the same amount as the shift amount between the center of the operation portion 25b and the center of the operation portion 25c in the circumferential direction, relative to the shaft 215 that rotatably supports the first lid operator 20b. The second lid operator 20c is rotatably supported by this shaft 215b. Thereby, the length L2 of the connection portion 26c is the same as the length L1 of the connection portion 26b.

This is to standardize the movement of the first lid operator 20b and the second lid operator 20c, which are keys integrated with lids, around the shafts 215 and 215b and to enable the lids to reliably close the tone holes without gaps, thereby stabilizing the pitch according to opening and closing. However, there is a problem that the structure of the flute becomes complicated due to the multiple shafts 215 and 215b provided for pitch stabilization. It is noted that, in the related art described in, for example, FIG. 26 of Japanese Patent Application Laid-Open No. 2017-219856, the same operation mechanism as a flute is adopted for the electronic wind instrument that imitates a flute, so the same problem exists.

In contrast, the electronic wind instrument 1 of this embodiment changes the pitch by pressing the switch 241 with the first lid operator 20b or the second lid operator 20c, so there is no need for the lids to reliably close the tone holes without gaps. Therefore, in the electronic wind instrument 1, there is no need to standardize the movement between the first lid operator 20b and the second lid operator 20c, and no problem occurs even in the case of the length L1 of the connection portion 26b and the length L2 of the connection portion 26c being made different according to the mutual shift of the operation portions 25b and 25c. Thus, the shaft 215 that respectively rotatably supports the first lid operator 20b and the second lid operator 20c may be arranged on a straight line, and the operation mechanism of the electronic wind instrument 1 may be simplified compared to the related art that has multiple shafts 215 and 215b.

In the non-pressed state (return-side restriction position CU1), the operation portion 25c of the second lid operator (long operator) 20c having the long connection portion 26c is inclined downward as it moves away from the shaft 215, relative to the operation portion 25b of the first lid operator (short operator) 20b having the short connection portion 26b. This enables the operation portions 25b and 25c to be arranged along the circumferential direction of the upper housing 21, and may bring the arrangement close to the key arrangement of a flute.

The force applied to the movable portion 243 of the switch 241 in the case of pressing the operation portions 25b and 25c becomes smaller as the pressing position is closer to the shaft 215, based on the principle of leverage. Since the length L1 of the connection portion 26b is shorter than the length L2 of the connection portion 26c, the force applied to the movable portion 243 from the first lid operator 20b is smaller than the force applied to the movable portion 243 from the second lid operator 20c.

Here, in the non-pressed state, the actuator 27b of the first lid operator 20b is inclined so that the tip end side moves away from the shaft 215 relative to the movement direction (up-down direction) of the movable portion 243. On the other hand, the actuator 27c of the second lid operator 20c is inclined so that the tip end side approaches the shaft 215 relative to the movement direction of the movable portion 243. Therefore, in the vicinity of the pressed state (pressing-side restriction position CL1), the inclination angle between the movement direction of the movable portion 243 and the actuator 27b becomes small (substantially 0 degrees in this embodiment), and the inclination angle between the movement direction of the movable portion 243 and the actuator 27c becomes large. Then, the proportion of the component of the force that presses the movable portion 243 among the force applied to the movable portion 243 from the first lid operator 20b increases, and the proportion of the component of the force that presses the movable portion 243 among the force applied to the movable portion 243 from the second lid operator 20c decreases.

Therefore, as described above, the force applied to the movable portion 243 from the first lid operator 20b is smaller than the force applied to the movable portion 243 from the second lid operator 20c, so the force that presses the movable portion 243 approaches the same degree between the first lid operator 20b and the second lid operator 20c. This may bring the reaction forces received by the performer according to the pressing force and the repulsive force of the elastic body 244 close to each other between the case of pressing the first lid operator 20b and the case of pressing the second lid operator 20c, and may suppress the differences in operation feel.

Further, in the non-pressed state, in the case of the actuators 27b and 27c respectively protruding from substantially the same positions of the operation portions 25b and 25c in parallel to the movement direction of the movable portion 243, since the connection portion 26c is longer than the connection portion 26b, the tip end of the actuator 27c moves further away from the shaft 215 toward the back side in the circumferential direction than the tip end of the actuator 27b. In contrast, in this embodiment, due to the above-described inclination of the actuators 27b and 27c in the non-pressed state, the tip ends of the actuators 27b and 27c approach each other in the circumferential direction.

Next, the first lever operator 20d and the surrounding configuration thereof will be described with reference to FIG. 6 and FIG. 8B. FIG. 8B is a cross-sectional view of the electronic wind instrument 1 at a position including the first lever operator 20d in a non-pressed state. Regarding the first lever operator 20d and the area around, description of portions similar to the first lid operator 20b and the area around will be partially omitted.

The connection portion 26d of the first lever operator 20d is formed in an arm shape with a cylindrical portion 261d, into which the shaft 215 is inserted, provided at the base end, similarly to the connection portion 26b of the first lid operator 20b, etc. By inserting the shaft 215 into the inner circumferential side of this cylindrical portion 261d, the first lever operator 20d is rotatably mounted to the upper housing 21. Further, in the first lever operator 20d, an actuator 27d protrudes downward from the connection portion 26d, and a cushion 271 is provided on the wall surface 217a side of the actuator 27d.

A rod-shaped operation portion 25d extends leftward in the axial direction from the tip end of the connection portion 26d, and a recess 253 for weight reduction is formed on the lower surface of the operation portion 25d. A length L3 of the connection portion 26d is formed longer than the lengths L1 and L2 of the connection portions 26b and 26c so that this operation portion 25d is positioned at the back in the circumferential direction relative to the operation portion 25c of the second lid operator 20c.

From the outer circumferential surface of the upper housing 21 on the lower side of the first lever operator 20d, a protruding portion 216d as a pressing-side stopper that restricts a downward rotation of the first lever operator 20d protrudes upward toward the connection portion 26d. It is noted that a cushion 251 for buffering is provided on the connection portion 26d at a position where this protruding portion 216d comes into contact.

In the non-pressed state, the actuator 27d of the first lever operator 20d is inclined so that the tip end side approaches the shaft 215 relative to the movement direction of the movable portion 243, similarly to the actuator 27c of the second lid operator 20c. Further, while the second lid operator 20c has the actuator 27c protruding from the operation portion 25c, the first lever operator 20d has the actuator 27d protruding from the connection portion 26d. This makes the arrangements of the actuator 27c and the actuator 27d with respect to the switch 241 substantially the same. As a result of these, the force with which the first lever operator 20d presses the movable portion 243 and the force with which the second lid operator 20c presses the movable portion 243 may be brought close to each other, and differences in operation feel during pressing may be suppressed.

Next, the second lever operators 20e, 20g, and 20i and the surrounding configuration thereof will be described with reference to FIG. 6 and FIG. 9A. FIG. 9A is a cross-sectional view of the electronic wind instrument 1 at a position including the second lever operator 20e in a non-pressed state. Regarding the second lever operator 20e and the area around, description of portions similar to the first lid operator 20b and the area around will be partially omitted.

The operation portions 25e, 25g, and 25i of the second lever operators 20e, 20g, and 20i are all formed in a rod shape extending in the circumferential direction of the upper housing 21. The length of the operation portion 25e in the circumferential direction is slightly smaller than the lengths of the operation portions 25g and 25i in the circumferential direction. Since the second lever operators 20e, 20g, and 20i are configured substantially identically in other respects, the second lever operator 20e and the area around shown in FIG. 9A will be mainly described, and part of other descriptions will be omitted.

A recess 253 for weight reduction is formed on the lower surface of the operation portion 25e. An actuator 27e protrudes downward from the bottom surface of the recess 253 of the operation portion 25e. A cushion 271 is provided on the wall surface 217a side of the actuator 27e below the operation portion 25e.

A connection portion 26e of the second lever operator 20e is formed only by a cylindrical portion having a cylindrical shape into which the shaft 215 is inserted. By inserting the shaft 215 into the inner circumferential side of the connection portion (cylindrical portion) 26e, the second lever operator 20e is rotatably mounted to the upper housing 21. It is noted that the connection portion 26e formed only by the cylindrical portion has a length from the axis center of the shaft 215 to the operation portion 25e of substantially zero.

The rod-shaped operation portion 25e protrudes backward and upward from the outer circumferential surface of the connection portion 26e in the non-pressed state. The performer basically operates the second lever operator 20e by pressing the tip end portion of the operation portion 25e away from the connection portion 26e with a finger. Therefore, the operation portion 25e is arranged to be shifted to the front side in the circumferential direction relative to the operation portion 25b, etc. so that the tip end portion of this operation portion 25e and the center of the disc-shaped operation portion 25b, etc. of the first lid operator 20b are at the same position in the circumferential direction of the upper housing 21.

On the outer circumferential surface of the upper housing 21 on the lower side of the second lever operator 20e, a pressing-side stopper 218 is provided that restricts a downward rotation of the second lever operator 20e. The pressing-side stopper 218 is formed by partially recessing the outer circumferential surface of the upper housing 21. It is noted that a cushion 251 for buffering is provided on the operation portion 25e at a position where this pressing-side stopper 218 comes into contact.

In the non-pressed state, the actuator 27e of the second lever operator (short operator) 20e is inclined so that the tip end side moves away from the shaft 215 relative to the movement direction of the movable portion 243, similarly to the actuator 27b of the first lid operator 20b. This may bring the force with which the second lever operator 20e presses the movable portion 243 close to the force with which the first lid operator 20b, etc. presses the movable portion 243, and may suppress differences in operation feel during pressing.

Furthermore, in the non-pressed state, the inclination angle between the movement direction of the movable portion 243 and the actuator 27e is larger than the inclination angle between the movement direction of the movable portion 243 and the actuator 27b. This may easily bring the tip ends of the actuators 27b and 27e close to each other in the circumferential direction even in the case of the connection portion 26e being shorter than the connection portion 26b.

Next, a rotation range CR2 of the first lever operator 20d and the second lever operator 20e (hereinafter “the first lever operator 20d, etc.”) will be described with reference to FIG. 9B. FIG. 9B is a schematic view showing the relationship between the rotation range CR2 of the first lever operator 20d, etc., the rotation range CR1 of the first lid operator 20b and the second lid operator 20c (hereinafter “the first lid operator 20b, etc.”), and the movable range SR of the movable portion 243 of the switch 241. In FIG. 9B, the height of the upper end of the movable portion 243 respectively at the threshold value ST, the upper limit position SU, the lower limit position SL, the return-side restriction positions CU1 and CU2, and the pressing-side restriction positions CL1 and CL2 is schematically illustrated.

The return-side restriction position CU2 shown in FIG. 9B is the height of the upper end of the movable portion 243 at the position where the actuators (return-side stoppers) 27d and 27e, etc. of the first lever operator 20d, etc. come into contact with the wall surface 217a of the through hole 217. The pressing-side restriction position CL2 is the height of the upper end of the movable portion 243 at the position where the connection portion 26d, the operation portion 25e, etc. of the first lever operator 20d, etc. come into contact with the protruding portion (pressing-side stopper) 216d and the pressing-side stopper 218.

The return-side restriction position CU2 is positioned below the return-side restriction position CU1 and the upper limit position SU, and above the threshold value ST. The pressing-side restriction position CL2 is positioned below the threshold value ST and the pressing-side restriction position CL1, and above the lower limit position SL. In this way, the relationship between the return-side restriction position CU2 and the pressing-side restriction position CL2, and the upper limit position SU, the lower limit position SL, and the threshold value ST of the pressing amount on the switch 241 side is the same as the relationship between the return-side restriction position CU1 and the pressing-side restriction position CL1 and the switch 241 side described above.

Furthermore, since the rotation ranges CR1 and CR2 of all the operators 20a to 20j are within the movable range SR of the movable portion 243 of the switch 241, there is no need to change the position of the switch 241 in the up-down direction for each of the operators 20a to 20j. Therefore, the switches 241 directly below the operators 20a to 20j may all be arranged on the same substrate 24.

The return-side restriction position CU2 is below the return-side restriction position CU1 and close to the threshold value ST. Therefore, in the case of rotating the first lid operator 20b, etc. and the first lever operator 20d, etc. by the same amount from the return-side restriction positions CU1 and CU2, the switch 241 of the first lever operator 20d, etc. switches to the pressed state first. Then, the switch 241 of the first lid operator 20b, etc. switches to the pressed state.

Here, during an operation of the lever of a flute, a lid that normally closes a tone hole is opened by the interlocking mechanism in response to the lever being pressed. During an operation of the lever of the flute, the pitch changes at the moment this tone hole opens, that is, in response to the lever starting to be pressed. On the other hand, during an operation of a key integrated with a lid that opens and closes a tone hole of a flute, the pitch changes in response to the key being pressed completely and the lid being closed.

The first lever operator 20d, etc. imitates the above-described lever of a flute, and the first lid operator 20b, etc. imitates the above-described key of a flute. Therefore, by setting the timing at which the switch 241 switches to the pressed state close to the return-side restriction position CU2 for the first lever operator 20d, etc., and far from the return-side restriction position CU1 for the first lid operator 20b, etc., it is possible to bring the timing at which the pitch of the electronic wind instrument 1 changes close to a flute.

Furthermore, since the pressing-side restriction position CL2 is below the pressing-side restriction position CL1, it is possible to set the rotation range CR2 and the rotation range CR1 to the same degree even in the case of the return-side restriction position CU2 being below the return-side restriction position CU1. The lever and key of a flute rotate the lid to open and close, and the rotation ranges of all lids are set to the same degree. That is, the rotation ranges of the lever and key are also set to the same degree. Therefore, by setting the rotation range CR2 and the rotation range CR1 to the same degree, the operation feel of the electronic wind instrument 1 may be brought close to the operation feel of a flute.

It is noted that, in this embodiment, with the return-side restriction position CU2 as 0 degrees, the rotation range CR2 to the pressing-side restriction position CL2 is set to approximately 10 degrees, similar to the rotation range CR1. However, this rotation range CR2 may be smaller or larger than 10 degrees, and may differ from the rotation range CR1. Further, in the case of the first lever operator 20d, etc. rotating approximately 6 degrees from the return-side restriction position CU2, the corresponding switch 241 switches to the pressed state. This switching position (threshold value ST) may be smaller or larger than 6 degrees, and is preferably set to approximately 2 to 4 degrees. With this approximately 2 to 4 degrees, the pitch may be changed in response to the first lever operator 20d, etc. starting to be pressed, and the timing at which the pitch of the electronic wind instrument 1 changes may be brought even closer to a flute.

In addition, the return-side restriction positions CU1 and CU2 relative to the movable range SR of the switch 241 may be easily adjusted by changing the lengths of the actuators 27b, 27c, 27d, 27e, etc. The pressing-side restriction positions CL1 and CL2 may be easily adjusted by changing the heights of the protruding portions 216b, 216c, 216d, etc. or the depth of the recess of the pressing-side stopper 218. For example, by moving the positions of the tip ends of the actuators 27b, 27c, 27d, 27e, etc. in the pressed state in parallel in the front-back direction, the rotation ranges CR1 and CR2 may also be adjusted without changing the return-side restriction positions CU1 and CU2. By using these, for example, the return-side restriction position CU1 and the return-side restriction position CU2 may be made different while keeping the pressing-side restriction position CL1 and the pressing-side restriction position CL2 the same.

According to the electronic wind instrument 1 described above, in the instrument body 2 in a range corresponding to the body tube of a flute, the rotation itself of the multiple operators 20a to 20j is directly detected by individual switches 241 to detect the pressed state or non-pressed state. Here, in a flute, there exist multiple operators such as keys and levers (components corresponding to the operators 20a to 20j) that the performer directly touches to perform an operation, and multiple interlocking lids that rotate in conjunction with the operation of the operators without being directly touched by the performer. Since some of the operators and interlocking lids interlocked in this manner may be separated, it is required to provide multiple shafts for transmitting the operation of the operators to the interlocking lids so as to bypass the shafts (components corresponding to the shaft 215) that rotatably support the operators.

However, there is a problem that the structure of the flute becomes complicated due to the multiple shafts provided for transmitting the operation. In the related art described in, for example, FIG. 26 of Japanese Patent Application Laid-Open No. 2017-219856, the same operation mechanism as a flute is adopted for the electronic wind instrument that imitates a flute, so the same problem exists. In particular, in the electronic wind instrument described in Japanese Patent Application Laid-Open No. 2017-219856, a sensor detects whether the tone hole has been reliably opened and closed by the interlocking lid to change the pitch. This is presumed to directly detect the opening and closing of the interlocking lid in order to approach the operation feel of a flute, which is reliable opening and closing.

In contrast, in the electronic wind instrument 1 of this embodiment, the rotation itself of the operators 20a to 20j that the performer directly touches to perform an operation in the range corresponding to the body tube is directly detected by individual switches 241 without using an interlocking mechanism. Therefore, it is possible to eliminate the interlocking lids of the flute and the sensors that directly detect the opening and closing of the interlocking lids described in Japanese Patent Application Laid-Open No. 2017-219856. Accordingly, for the electronic wind instrument 1, it is not required to provide shafts for the interlocking lids separately from the shaft 215 that rotatably supports the operators 20a to 20j. As a result, while imitating the operation of a flute in terms of the operation of the operators 20a to 20j, it is possible to suppress the operation mechanism of the electronic wind instrument 1 from becoming complicated due to multiple shafts arranged in the circumferential direction other than the shaft 215. That is, the operation mechanism of the electronic wind instrument 1 may be simplified.

Further, the operation portions 25a to 25j of the operators 20a to 20j are shifted in the circumferential direction, and the lengths L1 to L3 of the connection portions 26a to 26j are made different according to the shift amount. As a result, the shaft 215 for rotatably supporting all the operators 20a to 20j in the range corresponding to the body tube may be arranged on a straight line. In this respect as well, the operation mechanism of the electronic wind instrument 1 may be simplified.

Furthermore, the operators 20a to 20j respectively include the actuators 27a to 27j for pressing the switches 241. Therefore, even with a shift between the operation portions 25a to 25j in the circumferential direction, by setting the positions and lengths at which the actuators 27a to 27j protrude, the directions and angles of inclination of the actuators 27a to 27j relative to the movement direction of the movable portion 243, etc. according to the lengths L1 to L3, etc. as described above, the positions of the tip ends of the actuators 27a to 27j may be brought close to each other in the circumferential direction. This makes it easy to arrange the multiple switches 241 that the tip ends of the actuators 27a to 27j come into contact with on a straight line parallel to the shaft 215. As a result, the substrate 24 on which the multiple switches 241 are arranged may be easily made smaller in the circumferential direction, and the electronic wind instrument 1 in which the substrate 24 is built may be easily miniaturized.

The multiple switches 241 to be pressed by the operators 20a to 20j are arranged close to the shaft 215 side in the circumferential direction within the upper housing 21. This enables even the operators 20e, 20g, and 20i with short connection portions 26e, 26g, and 26i to press the switches 241 without forcibly extending the actuators 27e, 27g, and 27i toward the back side in the circumferential direction. Therefore, it is not required to change the positions of the multiple switches 241 in the circumferential direction according to the lengths L1 to L3 of the connection portions 26a to 26j, so the multiple switches 241 may be more easily arranged on a straight line.

As a result, the electronic wind instrument 1 may be more easily miniaturized. In this embodiment, all the switches 241 in the range corresponding to the body tube are actually aligned on a straight line parallel to the shaft 215, so miniaturization of the electronic wind instrument 1 may be achieved easier.

As shown in FIG. 6, in mounting each operator 20a to 20j to the upper housing 21, first, the cylindrical portions 261a to 261d, 261f, 261h, and 261j and the connection portions (cylindrical portions) 26e, 26g, and 26i are aligned between the multiple support portions 212a to 212c. Thereafter, by passing the shaft 215 through the inner circumferential side of these cylindrical portions 261a, etc. and the through holes 213 of the support portions 212a and 212b, and screwing the screw portion 215a of the shaft 215 into the bolt hole 214 of the support portion 212c, the operators 20a to 20j may be easily mounted to the upper housing 21. In particular, since the shaft 215 arranged on a straight line is formed by one continuous shaft, the mounting work may be made easier.

It is noted that steps 212d with the upper side recessed in the axial direction are formed on both left and right surfaces of the support portion 212b. Steps 262 with the lower side recessed in the axial direction are formed on the end surfaces of the cylindrical portions 261b to 261d, 261f, and 261h and the connection portions (cylindrical portions) 26e, 26g, and 26i that oppose both left and right surfaces of the support portion 212b. Before passing the shaft 215, the steps 262 are placed to overlap on the steps 212d, so that the cylindrical portions 261b, etc. may be roughly positioned relative to the support portions 212a to 212c. As a result, the mounting work of each operator 20a to 20j to the upper housing 21 may be made even easier.

These steps 212d and 262 are formed at positions where there is no contact within the rotation ranges CR1 and CR2 of the operators 20a to 20j after mounting. This is to prevent the rotation ranges CR1 and CR2 from being narrowed by such contact. However, the steps 212d and the steps 262 may be in contact within the rotation ranges CR1 and CR2, and at least one of the pressing-side stopper and the return-side stopper may be configured by such contact.

Next, the structure of the electronic wind instrument 1 at the position where the second lever operator 20k, the first interlocking operator 20m, and the second interlocking operator 20n are mounted will be described with reference to FIG. 10A to FIG. 11B. FIG. 10A is a partially enlarged top view of the electronic wind instrument 1 showing that position in an enlarged manner. FIG. 10B is a cross-sectional view of the electronic wind instrument 1 taken along line Xb-Xb of FIG. 10A. FIG. 11A is a cross-sectional view of the electronic wind instrument 1 taken along line XIa-XIa of FIG. 10A. FIG. 11B is a cross-sectional view of the electronic wind instrument 1 taken along line XIb-XIb of FIG. 10A.

As shown in FIG. 10A and FIG. 10B, the portion of the instrument body 2 where the operators 20k to 20n are mounted is a portion corresponding to the foot joint of a flute. On the inner circumferential side of the upper housing 21 at this portion, a substrate 28 and a support plate 29 are arranged. The support plate 29 is formed to incline downward toward the front side, and through holes 292 are formed in multiple mounting portions 291 extending from the support plate 29 toward both front and back sides. By screwing bolts B5 passing through the through holes 292 into bolt holes 211c of multiple bosses 211b that protrude downward from the inner circumferential surface of the upper housing 21, the support plate 29 is fixed to the upper housing 21. Furthermore, by overlapping the substrate 28 on the upper surface of the support plate 29 and screwing bolts B6 passing through through holes 281 of the substrate 28 into bolt holes 293 provided in the support plate 29, the substrate 28 is fixed to the upper housing 21 via the support plate 29.

The same support portions 212a, 212b, and 212c as the portion corresponding to the body tube rise upward from substantially the center in the front-back direction of the outer circumferential surface of the upper housing 21. The support portions 212a, 212b, and 212c are aligned on a straight line parallel to the axial direction of the upper housing 21, in this order from the right side to the left side. One shaft 219 is mounted on the outer circumferential side of the upper housing 21 so as to be bridged across these support portions 212a to 212c.

Each of the operators 20k to 20n is rotatably supported around this shaft 219 and provided on the front side of the shaft 219. Further, the second lever operator 20k is positioned on the leftmost side, and the first interlocking operator 20m and the second interlocking operator 20n are arranged side by side in the front-back direction on the right side thereof. Furthermore, the second interlocking operator 20n is positioned on the back side of the first interlocking operator 20m. On the right side of the first interlocking operator 20m and the second interlocking operator 20n, a first interlocking lid 41 that is not directly operated by the performer is provided, and on the right side thereof, a second interlocking lid 42 that is not directly operated by the performer either is provided.

The second lever operator 20k and the area around are configured substantially identically to the second lever operator 20e and the area around shown in FIG. 9A, differing only in a portion of the shape. The second lever operator 20k includes a plate-shaped operation portion 25k, a connection portion 26k including a cylindrical portion 261k, and an actuator (not shown), similar to the second lever operator 20e. By passing the shaft 219 through this cylindrical portion 261k, the second lever operator 20k is rotatably supported by the upper housing 21. A switch 241 (not shown) is provided on the substrate 28 directly below the second lever operator 20k. By operating the second lever operator 20k, this switch 241 directly detects the rotation of the second lever operator 20k.

The first interlocking operator 20m is a plate-shaped portion that is rotatably supported around the shaft 219 via the first interlocking lid 41. This first interlocking operator 20m is configured by an operation portion that the performer directly touches and operates, and does not have a connection portion or actuator like the first lid operator 20b, etc.

Therefore, no detection portion such as a switch 241 is provided directly below the first interlocking operator 20m. It is noted that the second interlocking operator 20n is not provided with an actuator either, and no detection portion such as a switch 241 is provided directly below the second interlocking operator 20n. This is because the second lever operator 20k, the first interlocking operator 20m, and the second interlocking operator 20n, which are respectively operated by the little finger of the right hand of the performer, are provided in a concentrated manner, making it difficult to provide anything other than the switch 241 for the second lever operator 20k.

The first interlocking lid 41 is formed in a disc shape that imitates a lid for opening and closing a tone hole in a flute. A cylindrical portion 411 in a cylindrical shape extending in a tangential direction is connected to the back side of the outer circumferential edge of this first interlocking lid 41. By passing the shaft 219 through the inner circumferential side of this cylindrical portion 411, the first interlocking lid 41 is rotatably mounted to the upper housing 21. The first interlocking operator 20m is connected to a connection portion 412 extending leftward from this first interlocking lid 41.

Accordingly, in the case of the first interlocking operator 20m being operated, the first interlocking lid 41 rotates in an interlocking manner. From the outer circumferential surface of the upper housing 21 on the lower side of the first interlocking operator 20m, a protruding portion 216m protrudes as a pressing-side stopper that restricts a downward rotation of the first interlocking operator 20m and the first interlocking lid 41. It is noted that a cushion 251 for buffering is provided on the first interlocking operator 20m at a position where this protruding portion 216m comes into contact.

As shown in FIG. 11A, a plate-shaped actuator 413 protrudes substantially vertically downward from the lower surface of the first interlocking lid 41. The tip end side of this actuator 413 is inserted into a through hole 217b provided in the upper housing 21. A switch 241a is provided on the substrate 28 directly below the first interlocking lid 41.

The switch 241a is configured substantially identically to the switch 241, except that the switch 241a incorporates an elastic body 244a having a smaller repulsive force than the elastic body 244 of the switch 241 shown in FIG. 7A, etc. In this embodiment, the repulsive force (spring constant) of the elastic body 244a is set to approximately half the repulsive force (spring constant) of the elastic body 244.

The switch 241a is arranged so that the movement direction of the movable portion 243 becomes the plate thickness direction of the substrate 28. Further, it is preferable that the shapes of the body portion 242 and the movable portion 243 differ between the switch 241 and the switch 241a. By making these different, it is possible to suppress the switch 241 and the switch 241a from being mistakenly mounted to the substrates 24 and 28 during assembly of the electronic wind instrument 1.

The tip end of the actuator 413 that passes through the through hole 217b comes into contact with the upper end of the movable portion 243 of this switch 241a. In the case of the first interlocking operator 20m being operated, the first interlocking lid 41 connected by the connection portion 412 rotates in an interlocking manner, and the tip end of the actuator 413 presses the movable portion 243, whereby the switch 241a detects the open/closed state of the first interlocking lid 41. The closed state in which the first interlocking lid 41 approaches the upper housing 21 indicates the pressed state of the first interlocking operator 20m. On the other hand, the open state in which the first interlocking lid 41 is separated from the upper housing 21 indicates the non-pressed state of the first interlocking operator 20m. That is, the switch 241a detects the operation of the first interlocking operator 20m through the open/closed state of the first interlocking lid 41.

In the lower right of FIG. 11A, the heights of the upper end of the movable portion 243 of the switch 241a at the return-side restriction position CU1, the pressing-side restriction position CL1, the upper limit position SU, the lower limit position SL, and the threshold value ST of the pressing amount are respectively schematically illustrated. This return-side restriction position CU1 is the height of the upper end of the movable portion 243 at the position where the upward rotation of the first interlocking operator 20m is restricted by a return-side stopper (such as a connection shaft 423 described later). The pressing-side restriction position CL1 is the height of the upper end of the movable portion 243 at the position where the downward rotation of the first interlocking operator 20m is restricted by a pressing-side stopper (protruding portion 216m). These relationships are similar to the relationship described regarding the first lid operator 20b with reference to FIG. 7A and FIG. 7B.

As shown in FIG. 10A and FIG. 10B, the second interlocking operator 20n includes an operation portion 25n that the performer directly touches and operates, and a connection portion 26n that connects the operation portion 25n to the shaft 219. The operation portion 25n is a rod-shaped portion extending in the left-right direction. The connection portion 26n is an arm-shaped portion extending in the circumferential direction of the upper housing 21, with the tip end connected to the operation portion 25n and the base end formed by a cylindrical portion 261n having a cylindrical shape. By inserting the shaft 219 into the inner circumferential side of the cylindrical portion 261n, the second interlocking operator 20n is rotatably mounted to the upper housing 21.

The second interlocking lid 42, similar to the first interlocking lid 41, is formed in a disc shape that imitates a lid for opening and closing a tone hole in a flute. A cylindrical portion 422 in a cylindrical shape extending in a tangential direction is connected to the back side of the outer circumferential edge of this second interlocking lid 42. By passing the shaft 219 through the inner circumferential side of this cylindrical portion 422, the second interlocking lid 42 is rotatably mounted to the upper housing 21.

The cylindrical portion 422 of the second interlocking lid 42 and the cylindrical portion 261n of the second interlocking operator 20n are connected by the connection shaft 423 provided on the back side thereof so as to bypass the shaft 219. Accordingly, in the case of the second interlocking operator 20n being operated, the second interlocking lid 42 rotates in an interlocking manner. Additionally, a plate portion 414 extends from the first interlocking operator 20m so as to slip to the lower side of the operation portion 25n of the second interlocking operator 20n. The upper surface of the plate portion 414 comes into contact with a cushion 254 mounted to the lower surface of the operation portion 25n. Accordingly, in the case of the second interlocking operator 20n being operated downward, the plate portion 414 is pressed downward, and the first interlocking operator 20m and the first interlocking lid 41 rotate in an interlocking manner.

On the other hand, in the case of the first interlocking operator 20m being operated, the plate portion 414 separates from the operation portion 25n, so the second interlocking operator 20n and the second interlocking lid 42 do not rotate in an interlocking manner. It is noted that, after the plate portion 414 separates from the operation portion 25n, the cushion 254 may suppress the impact sound and vibration at the time when these contact again.

Further, in the case of attempting to rotate the second interlocking operator 20n upward, the connection shaft 423 comes into contact with the upper housing 21, and the rotation thereof is restricted. In this way, the connection shaft 423 also serves as a return-side stopper that restricts an upward rotation of the second interlocking operator 20n. It is noted that, since a cushion 424 is mounted to the connection shaft 423 at a position where the connection shaft 423 comes into contact with the upper housing 21, the cushion 424 may suppress the impact sound and vibration at the time when these come into contact.

In the case of the first interlocking operator 20m, which is to be rotated upward, coming into contact with the second interlocking operator 20n whose rotation is restricted by the connection shaft 423 via the plate portion 414, the rotation thereof is restricted. Therefore, the plate portion 414, the second interlocking operator 20n, and the connection shaft 423 also serve as a return-side stopper that restricts an upward rotation of the first interlocking operator 20m.

As shown in FIG. 11B, a protruding portion 216n protrudes from the outer circumferential surface of the upper housing 21 on the lower side of the second interlocking lid 42 as a pressing-side stopper that restricts a downward rotation of the second interlocking operator 20n and the second interlocking lid 42. It is noted that a cushion 425 for buffering is provided on the second interlocking lid 42 at a position where this protruding portion 216n comes into contact.

A plate-shaped actuator 426 protrudes substantially vertically downward from the lower surface of the second interlocking lid 42. The tip end side of this actuator 426 is inserted into a through hole 217c provided in the upper housing 21. A switch 241b is provided on the substrate 28 directly below the second interlocking lid 42.

The switch 241b is configured substantially identically to the switch 241, except that the switch 241b incorporates an elastic body 244b having a smaller repulsive force than the elastic body 244 of the switch 241 shown in FIG. 7A, etc. In this embodiment, the repulsive force (spring constant) of the elastic body 244b is set to approximately half the repulsive force (spring constant) of the elastic body 244. That is, the switch 241b of this embodiment is configured identically to the switch 241a directly below the first interlocking lid 41.

The tip end of the actuator 426 that passes through the through hole 217c comes into contact with the upper end of the movable portion 243 of the switch 241b. In the case of the second interlocking operator 20n being operated, the second interlocking lid 42 rotates in an interlocking manner, and the tip end of the actuator 426 presses the movable portion 243, whereby the switch 241b detects the open/closed state of the second interlocking lid 42. The closed state in which the second interlocking lid 42 approaches the upper housing 21 indicates the pressed state of the second interlocking operator 20n. On the other hand, the open state in which the second interlocking lid 42 separates from the upper housing 21 indicates the non-pressed state of the second interlocking operator 20n. That is, the switch 241b detects the operation of the second interlocking operator 20n through the open/closed state of the second interlocking lid 42.

Furthermore, in the case of the second interlocking operator (third operator) 20n being pressed, the first interlocking operator (second operator) 20m is pressed in an interlocking manner, and both the first interlocking lid 41 and the second interlocking lid 42 are switched from the open state to the closed state. At this time, the elastic body 244a of the switch (second detection portion) 241a and the elastic body 244b of the switch (third detection portion) 241b are compressed simultaneously. Therefore, the performer receives both a second reaction force corresponding to the repulsive force of the elastic body 244a and a third reaction force corresponding to the repulsive force of the elastic body 244b from the second interlocking operator 20n. However, since the repulsive forces of the elastic bodies 244a and 244b are both approximately half the repulsive force of the elastic body 244 of the switch (first detection portion) 241, the reaction forces received by the performer in the case of pressing the second interlocking operator 20n and in the case of pressing the first lid operator (first operator) 20b, etc. may be brought close to each other, and the differences in operation feel therebetween may be suppressed.

It is noted that these reaction forces vary not only according to the repulsive forces of the elastic bodies 244, 244a, and 244b, but also according to the positional relationship between the shafts 215 and 219 which are the fulcrums, the operation portions 25b and 25n which are the effort points, and the tip ends of the actuators 27b, 413, and 426 which are the load points based on the principle of leverage. In this embodiment, the positional relationship between the fulcrum, effort point, and load point is substantially identical between the first lid operator 20b and the second interlocking operator 20n, so differences in reaction force may occur only due to the repulsive forces of the elastic bodies 244, 244a, and 244b.

Not limited to the case of this embodiment, it is preferable to set the second and third reaction forces corresponding to the repulsive forces of the elastic bodies 244a and 244b smaller than the first reaction force corresponding to the repulsive force of the elastic body 244 by appropriately adjusting the positional relationship between the fulcrum, effort point, and load point, and the repulsive forces of the elastic bodies 244, 244a, and 244b. Even in this case, the sum of the second reaction force and the third reaction force in the case of pressing the second interlocking operator 20n may be brought to a certain degree close to the first reaction force in the case of pressing the first lid operator 20b, etc.

Furthermore, it is more preferable that the sum of the second reaction force and the third reaction force is 1.3 times or less the first reaction force. This may bring the sum of the second reaction force and the third reaction force in the case of pressing the second interlocking operator 20n even closer to the first reaction force in the case of pressing the first lid operator 20b, etc. Moreover, it is even more preferable that the sum of the second reaction force and the third reaction force is 0.7 times or more the first reaction force. This may prevent the sum of the second reaction force and the third reaction force in the case of pressing the second interlocking operator 20n from becoming too light compared to the first reaction force in the case of pressing the first lid operator 20b, etc., and may bring these reaction forces close to the same degree.

It is noted that, not limited to the case where the second reaction force and the third reaction force are identical, the second reaction force on the elastic body 244a side may be set larger than the third reaction force on the elastic body 244b side by setting the repulsive force of the elastic body 244a approximately twice the repulsive force of the elastic body 244b. In this case, the sum of the second reaction force and the third reaction force in the case of pressing the second interlocking operator 20n may be brought close to the second reaction force in the case of pressing only the first interlocking operator 20m, and the differences in operation feel therebetween may be suppressed.

In the lower right of FIG. 11B, the heights of the upper end of the movable portion 243 of the switch 241b at the return-side restriction position CU3, the pressing-side restriction position CL3, and the threshold value ST of the pressing amount are respectively schematically illustrated. The return-side restriction position CU3 is the height of the upper end of the movable portion 243 at the position where the upward rotation of the second interlocking operator 20n is restricted by the return-side stopper (connection shaft 423), and is positioned above the threshold value ST. The pressing-side restriction position CL3 is the height of the upper end of the movable portion 243 at the position where the downward rotation of the second interlocking operator 20n is restricted by the pressing-side stopper (protruding portion 216n), and is positioned below the threshold value ST. Although not illustrated, the return-side restriction position CU3 and the pressing-side restriction position CL3 are within the movable range SR from the upper limit position SU to the lower limit position SL.

Furthermore, in the lower right of FIG. 11B, the heights of the upper end of the movable portion 243 of the switch 241a at the return-side restriction position CU1 and the pressing-side restriction position CL1 of the first interlocking operator 20m are respectively schematically illustrated. It is noted that the height of the upper end of the movable portion 243 at the threshold value ST of the pressing amount is identical between the switch 241a and the switch 241b.

At the return-side restriction positions CU1 and CU3, the first interlocking lid 41 and the second interlocking lid 42 are opened upward by the same amount, but since the length L6 of the actuator 426 is slightly longer (for example, 0.1 mm) than the length L5 of the actuator 413, the return-side restriction position CU3 is below the return-side restriction position CU1. It is noted that in FIG. 11B, these differences are shown in an exaggerated manner.

For example, a case where the lengths L5 and L6 are set identical and the return-side restriction positions CU1 and CU3 are set identical is examined here. In this case, in response to the second interlocking operator 20n being pressed to interlock the first interlocking lid 41 and the second interlocking lid 42, the switches 241a and 241b simultaneously detect the closed state (pressed state) if the lengths L5 and L6 are the values as designed.

However, due to dimensional errors of each portion and individual differences of the switches 241a and 241b, there is a possibility that the switch 241a detects the closed state of the first interlocking lid 41 first, and immediately thereafter the switch 241b detects the closed state of the second interlocking lid 42, in the case of the second interlocking operator 20n being pressed. In this case, the pitch in the case of the second interlocking operator 20n being in the pressed state may be produced immediately after production of the pitch in the case of the first interlocking operator 20m being in the pressed state.

In contrast, in this embodiment, the return-side restriction position CU3 is below the return-side restriction position CU1, so the pressing amount TL of the switch 241a at that time is positioned above the threshold value ST even in the case of the pressing amount of the switch 241b becoming identical to the threshold value ST. Therefore, in the case of the second interlocking operator 20n being pressed, the switch 241b detects the closed state of the second interlocking lid 42 first, and after further pressing, the switch 241a detects the closed state of the first interlocking lid 41. In other words, in the rotation range CR3 of the second interlocking operator 20n, there exists a range (between the pressing amount TL and the threshold value ST) where the switch 241b detects the closed state while the switch 241a detects the open state. As a result, despite that there are dimensional errors of each portion and individual differences of the switches 241a and 241b, it is possible to suppress the pitch in the case of the second interlocking operator 20n being in the pressed state from being produced immediately after production of the pitch in the case of the first interlocking operator 20m being in the pressed state.

Furthermore, the electronic wind instrument 1 is controlled to produce the pitch in the case of the second interlocking operator 20n being in the pressed state, in response to the switch 241b being in the closed state, even if the switch 241a is not in the closed state. This enables the pitch in the case of the second interlocking operator 20n being in the pressed state to be produced without waiting for both the switches 241a and 241b to detect the closed state, thereby improving the responsiveness to the operation of the second interlocking operator 20n.

Further, the pressing-side restriction position CL3 is below the pressing-side restriction position CL1 by the same amount as the difference between the return-side restriction positions CU1 and CU3. This may set the rotation range CR1 of the first interlocking lid 41 and the rotation range CR3 of the second interlocking lid 42 to be identical. It is noted that, in the case of the second interlocking operator 20n being pressed, the first interlocking lid 41 and the second interlocking lid 42 rotate in an interlocking manner. Therefore, the rotation range of the second interlocking operator 20n becomes the narrower one of the rotation ranges CR1 and CR3. On the other hand, in the case of the first interlocking operator 20m being pressed, only the first interlocking lid 41 rotates. Therefore, the rotation range of the first interlocking operator 20m becomes the rotation range CR1. Thus, in the case where the rotation range CR1 and the rotation range CR3 are identical, the rotation range of the second interlocking operator 20n becomes the rotation range CR1 (=CR3), and becomes identical to the rotation range of the first interlocking operator 20m. Accordingly, it is possible to suppress differences in operation feel caused by different rotation ranges in the case of pressing the first interlocking operator 20m and in the case of pressing the second interlocking operator 20n.

In the electronic wind instrument 1, the shafts that rotatably support the operators 20a to 20j and 20k to 20n are limited to the shaft 215 and the shaft 219. Here, since the shaft that rotatably supports both the first interlocking operator 20m and the second interlocking operator 20n is the shaft 219, neither the connection portion 412 nor the connection shaft 423 is included in the shafts that rotatably support the operators. The shaft 215 and the shaft 219 do not overlap in both the circumferential direction and the axial direction of the electronic wind instrument 1. To rephrase that the shaft 215 and the shaft 219 do not overlap in the circumferential direction of the electronic wind instrument 1, there is one or fewer shaft that rotatably supports multiple operators in the circumferential direction at any position on the outer side of the housing of the electronic wind instrument 1.

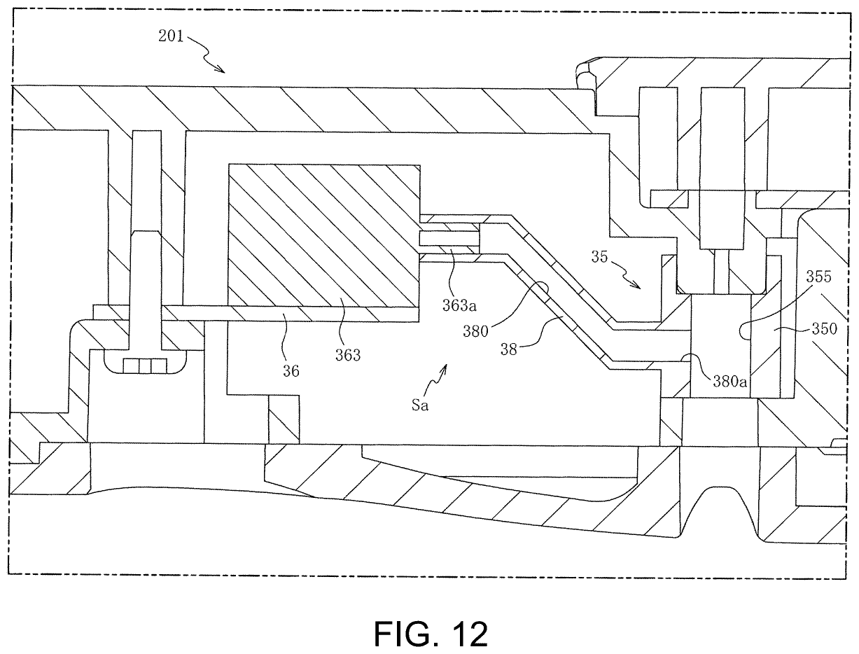

Next, the electronic wind instrument 201 of the second embodiment will be described with reference to FIG. 12. In the first embodiment, the case of detecting temperature change of air in the branch flow path 356 heated by the heater 362 with the temperature sensor 360 was described, but in the second embodiment, the case of detecting change in airflow (air pressure) in the branch flow path 380 using the pressure sensor 363 will be described. It is noted that the same reference numerals are assigned to the same portions as in the above-described first embodiment, and description thereof will be omitted.

As shown in FIG. 12, the sensor module Sa of the electronic wind instrument 201 of the second embodiment is provided with a pressure sensor 363 instead of the temperature sensor 360 and heater 362 (see FIG. 4) described in the first embodiment, and a cylindrical conduit 38 is provided instead of each wall portion 351 to 353 (see FIG. 4) of the case 35. The pressure sensor 363 is a sensor that detects changes in air pressure, and since a known configuration may be adopted, detailed description will be omitted.

The pressure sensor 363 is mounted on the upper surface of the substrate 36, and the pressure sensor 363 is formed with a cylindrical connection port 363a. One end of the conduit 38 is connected to the connection port 363a, and the other end of the conduit 38 is connected to the cylinder portion 350 of the case 35. It is noted that the conduit 38 may be formed integrally with the case 35 (cylinder portion 350), or may be a separate pipe from the case 35 (e.g., a flexible tube).

The cavity inside the conduit 38 is configured as a branch flow path 380, and an opening 380a of this branch flow path 380 is formed on the inner circumferential surface of the cylinder portion 350 (case side flow path 355). That is, also in this embodiment, the branch flow path 380 branches so as to intersect with the case side flow path 355. In response to a change in the flow rate (flow velocity) of exhaled air flowing in the main flow path (case side flow path 355), a change also occurs in the airflow generated in the branch flow path 380 (sub flow path branching from the main flow path), and this change in airflow (air pressure) in the branch flow path 380 is detected by the pressure sensor 363.

Also in this embodiment, the cross-sectional area of the opening 380a of the branch flow path 380 is formed smaller than the cross-sectional area of the part (case side flow path 355) where the opening 380a of the branch flow path 380 is connected in the main flow path. This provides an effect that exhaled air containing moisture becomes difficult to flow into the pressure sensor 363 side. Factors for obtaining this effect include that exhaled air passing through the case side flow path 355 becomes difficult to flow into the branch flow path 380 side, and that negative pressure is generated in the branch flow path 380 by exhaled air passing through the case side flow path 355, and air in the branch flow path 380 is sucked from the opening 380a into the case side flow path 355 by the negative pressure.

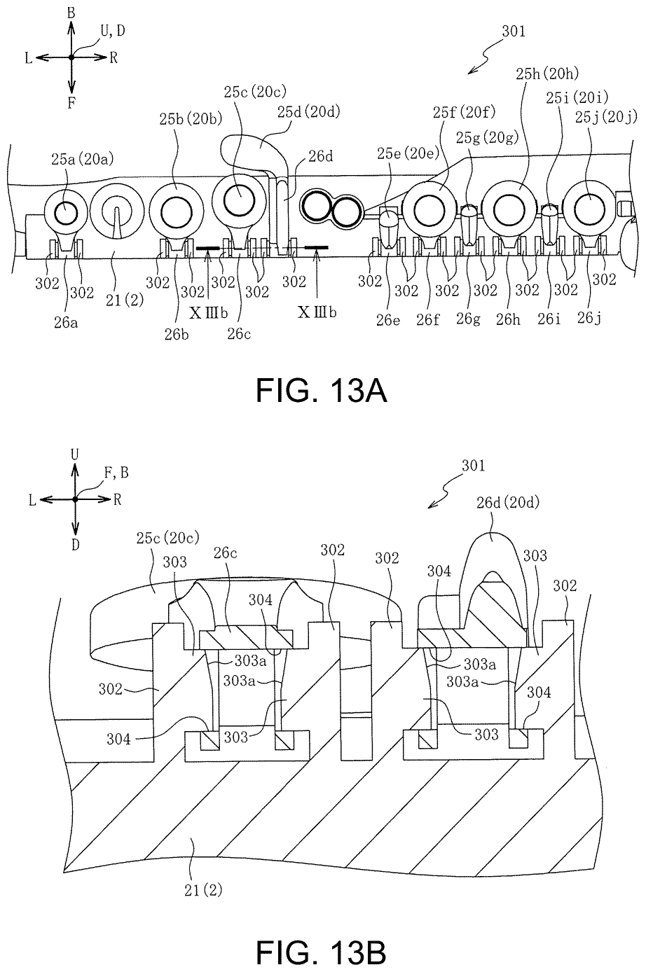

Next, the electronic wind instrument 301 of the third embodiment will be described with reference to FIG. 13. In the first embodiment, the case in which the operators 20a to 20j are respectively rotatably mounted to the upper housing 21 by one shaft 215 arranged on a straight line was described. In the third embodiment, a case in which the operators 20a to 20j are respectively rotatably mounted to the upper housing 21 by multiple shafts 303 arranged on a straight line will be described. It is noted that the same reference numerals are assigned to the same portions as in the above-described first embodiment, and description thereof will be omitted.

FIG. 13A is a partially enlarged top view of the electronic wind instrument 301 of the third embodiment. FIG. 13B is a partially enlarged cross-sectional view of the electronic wind instrument 301 taken along line XIIIb-XIIIb of FIG. 13A. A support portion 302 of the electronic wind instrument 301 is a set of two plate members arranged to sandwich the connection portions 26a to 26j from both left and right sides for each of the operators 20a to 20j, and rises upward from the front side of the outer circumferential surface of the upper housing 21.

First, the mounting structure of the second lid operator 20c to the support portion 302 will be described. Shafts 303 protrude toward each other from a set of support portions 302, and the tip ends of these shafts 303 are separated in the left-right direction and oppose each other. At the base end of the connection portion 26c of the operator 20c, fitting holes 304 having an inner diameter substantially identical to the outer diameter of the shafts 303 are formed to open on both left and right surfaces. By inserting the base end of the connection portion 26c between the support portions 302 while elastically deforming a set of support portions 302 in directions away from each other, the shafts 303 fit into the fitting holes 304, and the second lid operator 20c is rotatably mounted to the upper housing 21.

On the upper side of the tip ends of the shafts 303, guide surfaces 303a are formed that are inclined so that the interval between the tip ends widens upward. Thus, by pressing the base end of the connection portion 26c downward while contacting the guide surfaces 303a during mounting of the second lid operator 20c to the upper housing 21, a set of support portions 302 may be elastically deformed easily in directions away from each other, and the mounting work may be made easier.

The mounting structure of each of the operators 20a, 20b, and 20d to 20j to the support portion 302 is the same as the mounting structure of the second lid operator 20c to the support portion 302. The shafts 303 that respectively rotatably support each of the operators 20a to 20j are arranged on a straight line parallel to the axial direction of the upper housing 21, and divided into multiple parts in the axial direction. Therefore, in the electronic wind instrument 301 of the third embodiment, similar to the first embodiment, while imitating the operation of a flute in terms of the operation of the operators 20a to 20j, there is no need to arrange shafts in multiple parts in the circumferential direction other than the shafts 303, making it possible to simplify the operation mechanism of the electronic wind instrument 301.

Next, the electronic wind instrument 401 of the fourth embodiment will be described with reference to FIG. 14A. In the first embodiment, the case in which the operation of the first lid operator 20b is transmitted to the switch 241 by the actuator 27b was described. In the fourth embodiment, a case in which the first lid operator 20b does not have the actuator 27b will be described. It is noted that the same reference numerals are assigned to the same portions as in the above-described first embodiment, and description thereof will be omitted.

FIG. 14A is a cross-sectional view of the electronic wind instrument 401 at a position including the first lid operator 20b in a non-pressed state. In FIG. 14A, a cross-section cut along a plane orthogonal to the axial direction of the electronic wind instrument 401 is illustrated, and illustration of a portion of the configuration on the far side from the cross-section is omitted. It is noted that, although the first lid operator 20b and the switch 402 directly below the first lid operator 20b will be described, the other operators 20a and 20c to 20k and the switches 402 directly below the other operators 20a and 20c to 20k may be configured similarly.

The switch 402 of the electronic wind instrument 401 has the same basic structure as the Specifically, in the switch 402, a movable portion switch 241 described in the first embodiment. 404 protrudes and retracts from the upper surface of a body portion 403 fixed to the substrate 24, and an elastic body 244 is compressed between the body portion 403 and the movable portion 404. The body portion 403 includes an edge portion 242a, and the movable portion 404 includes a flange 243a.

Unlike the movable portion 243 of the switch 241 of the first embodiment that is contained inside the upper housing 21, the movable portion 404 of the switch 402 protrudes toward the outer side of the upper housing 21 through a through hole 405 provided in the upper housing 21. The operation portion 25b of the first lid operator 20b is placed via a cushion 251 on the upper end of the movable portion 404 positioned above the protruding portion 216b of the upper housing 21. Thus, in the case of the first lid operator 20b being operated downward by the performer, the movable portion 404 movable in the up-down direction is pressed by the operation portion 25b, and the movable portion 404 is pressed against the repulsive force of the elastic body 244.

In the case of the performer releasing the first lid operator 20b from pressing, the first lid operator 20b rotates so as to be lifted upward by the repulsive force of the elastic body 244, and this upward rotation is restricted by a return-side stopper 406 provided on the first lid operator 20b. The return-side stopper 406 is provided in place of the actuator 27b of the first embodiment.

The return-side stopper 406 is a plate-shaped portion that protrudes substantially vertically from the lower surface of the operation portion 25b. The tip end (lower end) side of the return-side stopper 406 is inserted into a non-through recess portion 407 formed by recessing the outer circumferential surface of the upper housing 21 toward the inside of the upper housing 21. The return-side stopper 406 comes into contact with the wall surface 217a on the back side of this recess portion 407 via the cushion 271, thereby restricting the upward rotation of the first lid operator 20b. Since the return-side stopper 406 restricts a rotation by utilizing the inner side of the outer circumferential surface of the upper housing 21 in this way, the appearance of the electronic wind instrument 401 may be simplified, and the electronic wind instrument 401 may be easily miniaturized.

In the fourth embodiment, similar to the first embodiment, at the return-side restriction position CU1 (non-pressed state) where the return-side stopper 406 comes into contact with the wall surface 217a, the repulsive force of the elastic body 244 is constantly applied to the first lid operator 20b, and the return-side stopper 406 is pressed against the wall surface 217a. This enables the first lid operator 20b to the movable portion 404 to be maintained in a basically constantly contacted state, so that differences in pressing feel caused by spanning contact/non-contact of some of those components may be less likely to occur.

Next, the electronic wind instrument 501 of the fifth embodiment will be described with reference to FIG. 14B. In the first embodiment, the case in which the actuator 27b also serves as a return-side stopper was described. In the fifth embodiment, a case in which the actuator 27b and a return-side stopper 504 are separately provided will be described. It is noted that the same reference numerals are assigned to the same portions as in the above-described first embodiment, and description thereof will be omitted.

FIG. 14B is a cross-sectional view of the electronic wind instrument 501 at a position including the first lid operator 20b in a non-pressed state. In FIG. 14B, a cross-section cut along a plane orthogonal to the axial direction of the electronic wind instrument 501 is illustrated, and illustration of a portion of the configuration on the far side of the cross-section is omitted. It is noted that, although the actuator 27b and the return-side stopper 504 of the first lid operator 20b will be described, the actuators 27a and 27c to 27j and the return-side stoppers 504 of the other operators 20a and 20c to 20j may be configured similarly.

The first lid operator 20b of the electronic wind instrument 501 includes the actuator 27b and the return-side stopper 504. The actuator 27b protrudes downward from the operation portion 25b, and comes into contact with the movable portion 243 of the switch 241 through a through hole 502 provided in the upper housing 21. The through hole 502 is formed large so that the actuator 27b does not come into contact with the wall surface thereof at the return-side restriction position CU1 (non-pressed state). That is, in the electronic wind instrument 501, the actuator 27b does not serve as a return-side stopper.

The return-side stopper 504 is formed to extend from the cylindrical portion 261b of the first lid operator 20b toward the opposite side from the operation portion 25b. The return-side stopper 504 comes into contact with the outer circumferential surface of the upper housing 21, thereby restricting an upward rotation of the first lid operator 20b. It is noted that a cushion 505 composed of an elastic member is mounted to a portion of the return-side stopper 504 that comes into contact with the upper housing 21. This enables the cushion 505 to suppress the impact sound and vibration at the time when the return-side stopper 504 and the upper housing 21 come into contact with each other.

In the fifth embodiment, similar to the first embodiment, at the return-side restriction position CU1 where the return-side stopper 504 comes into contact with the upper housing 21, the repulsive force of the elastic body 244 is constantly applied to the first lid operator 20b, and the return-side stopper 504 is pressed against the upper housing 21. This enables the first lid operator 20b to the movable portion 243 to be maintained in a basically constantly contacted state, so that differences in pressing feel caused by spanning contact/non-contact of some of those components may be less likely to occur.

The above description has been made based on the above embodiments, but the disclosure is not limited to the above embodiments in any way, and it may be easily inferred that various improvements and modifications are possible within the scope that does not depart from the spirit of the disclosure.

In each of the above embodiments, the case where the electronic wind instruments 1 and 201 are electronic musical instruments that imitate a flute has been described, but the disclosure is not necessarily limited thereto. For example, the electronic wind instruments 1 and 201 may imitate other wind instruments (saxophone, clarinet, recorder, hulusi, piccolo, etc.).

In each of the above embodiments, the configuration in which each bent flow path 314a and 315a is heated by the heater 341, that is, the configuration in which the substrate 34 is provided on the bottom surface 322a of the mounting hole 322 of the lip plate 31, has been described, but the disclosure is not necessarily limited thereto. For example, the substrate 34 (heater 341) may be provided on the inner circumferential surface of the air inlet side housing 32 on the opposite side from the bottom surface 322a, or the substrate 34 (heater 341) may be provided on the bottom surface 322a or the inner circumferential surface of the air inlet side housing 32. Further, a substrate (heater) for heating the case side flow path 355 may be provided.

In each of the above embodiments, the case where the main flow path is composed of the first bent flow path 314a, the second bent flow path 315a, the housing side flow path 323, the restricted flow path 326, and the case side flow path 355 has been described, but the disclosure is not necessarily limited thereto. For example, among the connection portions of the respective flow paths 314a, 315a, 323, 326, and 355, another flow path may be added to some or all of the connection portions, or a portion of each flow path 314a, 315a, 323, 326, and 355 may be bent. That is, the shape of the main flow path connecting from each air inlet 310 and 311 to the first exhaust port 334 may be arbitrarily changed, and the disclosure may be applied to any electronic wind instrument that includes at least a branch flow path that branches so as to intersect with the main flow path.

In each of the above embodiments, the case where the case side flow path 355, which is a portion of the main flow path, is formed by the case 35 of the sensor modules Sa and Sb (the sensor modules Sa and Sb include a portion of the main flow path) has been described, but the disclosure is not necessarily limited thereto. For example, in addition to the case side flow path 355, the sensor modules Sa and Sb may include some or all of the first bent flow path 314a, the second bent flow path 315a, the housing side flow path 323, and the restricted flow path 326. That is, portions of the lip plate 31, the air inlet side housing 32 (e.g., the mounting hole 322 and the lower protrusion 325), and a portion or all of the substrate 34 that form the main flow path may be used as components of the sensor modules Sa and Sb.

In each of the above embodiments, the case where the first bent flow paths 314a and 314b and the second bent flow paths 315a and 315b are formed in the lip plate 31 has been described, but the disclosure is not necessarily limited thereto. For example, either one of the first bent flow paths 314a and 314b and the second bent flow paths 315a and 315b may not be provided, and each air inlet 310 and 311 and the housing side flow path 323 may be connected via the other bent flow path. Further, both the first bent flow paths 314a and 314b and the second bent flow paths 315a and 315b may not be provided, and each air inlet 310 and 311 and the housing side flow path 323 may be connected linearly.

In each of the above embodiments, the case where the restricted flow paths 316a and 326 are formed in the middle of each bent flow path 314a and 315a or between the housing side flow path 323 and the case side flow path 355 (i.e., in the main flow path upstream of the branch flow path) has been described, but the disclosure is not necessarily limited thereto. For example, either one or both of the restricted flow paths 316a and 326 may not be provided, or a restricted flow path may be formed in the case side flow path 355 (i.e., in the case 35).

In each of the above embodiments, the case where the leak flow path 322b is formed in the second bent flow path 315a (the main flow path upstream of the branch flow path) has been described, but the disclosure is not necessarily limited thereto. For example, a configuration that does not have the leak flow path 322b (sealing the gap between the substrate 34 and the air inlet side housing 32) may be used, or a flow path corresponding to the leak flow path 322b may be formed in other parts of the main flow path.

In each of the above embodiments, the case where the first and second exhaust ports 334 and 335 are formed in the exhaust side housing 33 has been described, but the disclosure is not necessarily limited thereto. For example, an exhaust port corresponding to the first exhaust port 334 (i.e., an exhaust port that exhausts exhaled air from the main flow path) may be formed in the air inlet side housing 32, or an exhaust port for ventilating the internal space S1 of each housing 32 and 33 may be formed in the air inlet side housing 32 without providing the second exhaust port 335 (or in addition to the second exhaust port).

In each of the above embodiments, the case where the opening dimension in the circumferential direction of the second exhaust port 335 expands toward the outer circumferential side has been described, but the disclosure is not necessarily limited thereto. For example, the opening dimension in the circumferential direction of the second exhaust port 335 may be constant from the inner circumferential side to the outer circumferential side, or may narrow from the inner circumferential side to the outer circumferential side.

In each of the above embodiments, the case where each exhaust port 334 and 335 and the recess portion 333b are covered by the decorative body 37 in which the first to third covering portions 370 to 372 are integrally formed has been described, but the disclosure is not necessarily limited thereto. For example, the first to third covering portions 370 to 372 may be formed separately, or part or all of the first to third covering portions 370 to 372 may not be provided.

In each of the above embodiments, the case where the second exhaust port 335 is covered by the second covering portion 371 extending in the axial direction has been described, but the disclosure is not necessarily limited thereto. For example, similar to the first covering portion 370 and the third covering portion 372, the second exhaust port 335 may be covered with a covering portion having a through hole penetrating in the radial direction, or the first exhaust port 334 and the recess portion 333b may be covered by a covering portion extending in the axial direction.

In each of the above embodiments, the case where a pair of inclined surfaces 371a are formed on the inner circumferential surface of the second covering portion 371 so as to be arranged via a ridge line has been described, but the disclosure is not necessarily limited thereto. For example, a flat surface or a curved surface may be formed at the boundary part between the pair of inclined surfaces 371a, or the inner circumferential surface of the second covering portion 371 may be a flat surface.

In each of the above embodiments, bolts are used to fix the members constituting the electronic wind instrument 1 to each other, but other screw parts or fastening parts may be used.

In the first embodiment described above, the case where the protrusion portion 357 is formed on the inner circumferential surface of the case side flow path 355 (main flow path) has been described, but the disclosure is not necessarily limited thereto. For example, the protrusion portion 357 may not be provided, and the opening 356a of the branch flow path 356 may be formed on the inner circumferential surface of the case side flow path 355. Further, the protrusion portion 357 connected to the conduit 38 (branch flow path 380) may be formed on the inner circumferential surface of the case side flow path 355 of the second embodiment.

In the first embodiment described above, the case where the tapered surface 356c is formed in the branch flow path 356 has been described, but the disclosure is not necessarily limited thereto. For example, the tapered surface 356c may not be provided and the cross-sectional area of the branch flow path 356 may be constant over two ends in the axial direction, or a surface similar to the tapered surface 356c may be formed on the opening 356b side.

In the first embodiment described above, the case where the ventilation opening 333c that connects the opening 356b of the branch flow path 356 to the outside is formed in the boss 333 (recess portion 333b) has been described, but the disclosure is not necessarily limited thereto. For example, the opening 356b of the branch flow path 356 may be connected to the outside via a ventilation opening (exhaust port) provided in a part separate from the boss 333 (recess portion 333b).

In each of the above embodiments, the case where the detection portions that detect the operation state (operation) of the operators 20a to 20n are the switches 241, 241a, 241b, and 402 has been described, but the disclosure is not necessarily limited thereto. For example, the detection portion may be a contact type sensor such as a pressure sensor, a non-contact type sensor such as an optical sensor, a rotary encoder, or the like. Additionally, the specific structures of the switches 241, 241a, 241b, and 402 are not limited to the structures described above, and known structures may be used.

Further, the case where the threshold values ST of the switches 241, 241a, 241b, and 402 are all the same has been described, but the disclosure is not necessarily limited thereto. For example, by setting the threshold value ST to be different for each of the multiple switches 241, or by setting the threshold value ST of the switch 241a to be different from the threshold value ST of the switch 241b, the timing at which the on/off state of the switches 241, 241a, 241b, and 402 switches may be appropriately changed.

Specifically, the threshold value ST of the switch 241 directly below the first lid operator 20b, etc. may be moved away from the return-side restriction position CU1, and the threshold value ST of the switch 241 directly below the first lever operator 20d, etc. may be brought close to the return-side restriction position CU2. Accordingly, even in the case of the return-side restriction positions CU1 and CU2 being identical, the pitch may be changed in response to the first lid operator 20b, etc. being pressed completely, or the pitch may be changed at an early stage where the first lever operator 20d, etc. starts to be pressed, and the timing at which the pitch of the electronic wind instrument 1, etc. changes may be brought close to a flute.

In addition, the threshold value ST of the switch 241a may be moved away from the return-side restriction position CU1, and the threshold value ST of the switch 241b may be brought close to the return-side restriction position CU3. Accordingly, even in the case of the lengths L5 and L6 of the actuators 413 and 426 being identical and the return-side restriction positions CU1 and CU3 being identical, the switch 241b may be switched to the on state first in response to the second interlocking operator 20n being pressed, and the switch 241a may be switched to the on state later.

Furthermore, instead of setting the lengths of the actuators 27a to 27j, 413, and 426 to be different, spacers may be mounted to the upper ends of the movable portions 243 and 404 to appropriately change the timing at which the on/off state of the switches 241, 241a, 241b, and 402 switches. In addition, by setting the heights of specific switches 241 and 402 to be different from the heights of other switches 241 and 402, or by setting the height of the switch 241a to be different from the height of the switch 241b, the timing at which the on/off state of the switches 241, 241a, 241b, and 402 switches may be appropriately changed.

In each of the above embodiments, the case where the actuators 27a to 27c and 27e to 27j protrude from the operation portions 25a to 25c and 25e to 25j, and the actuator 27d protrudes from the connection portion 26d has been described, but the disclosure is not necessarily limited thereto. The actuators 27a to 27c, 27f, 27h, and 27j may protrude from the arm-shaped connection portions 26a to 26c, 26f, 26h, and 26j, and the actuator 27d may protrude from the operation portion 25d. Further, the shapes of the actuators 27a to 27j are not limited to a shape that protrudes straight from the operation portion 25a, etc. toward the tip end, and may be curved toward the tip end.

In the first embodiment described above, the case where the operators 20a to 20j are mounted to the upper housing 21 by one shaft 215 arranged on a straight line has been described, but the disclosure is not necessarily limited thereto. For example, the shaft 215 arranged on a straight line may be divided into multiple parts in the axial direction thereof. Specifically, the operators 20a to 20d may be mounted to the upper housing 21 by one shaft 215, and the operators 20e to 20j may be mounted to the upper housing 21 by another shaft 215.

What is claimed is:

1. An electronic wind instrument, comprising:
a housing;
an operator supported on outside of the housing to be rotatable in a pressing direction approaching the housing and a return direction opposite to the pressing direction;
a detection portion detecting an operation to the operator; and
a return-side stopper restricting a rotation of the operator in the return direction,
wherein the detection portion comprises a movable portion that moves with a rotation of the operator and an elastic body that generates a repulsive force for rotating the operator in the return direction via the movable portion, and
the repulsive force of the elastic body is applied to the operator in a state where a rotation of the operator in the return direction is restricted by the return-side stopper.

2. The electronic wind instrument according to claim 1, wherein the operator comprises at least three operators that are a first operator, a second operator and a third operator,
the detection portion comprises at least three detection portions that are a first detection portion, a second detection portion and a third detection portion,
a movable portion of the first detection portion moves by a rotation of the first operator that is in contact with the movable portion of the first detection portion,
the electronic wind instrument comprises an interlocking mechanism that moves a movable portion of the second detection portion by a rotation of the second operator and moves movable portions of both the second detection portion and the third detection portion by a rotation of the third operator, and
a second reaction force generated in response to a repulsive force of an elastic body of the second detection portion in a case of the second operator or the third operator being rotated in the pressing direction and a third reaction force generated in response to a repulsive force of an elastic body of the third detection portion in a case of the third operator being rotated in the pressing direction are respectively smaller than a first reaction force generated in response to a repulsive force of an elastic body of the first detection portion in a case of the first operator being rotated in the pressing direction.

3. The electronic wind instrument according to claim 2, wherein the return-side stopper is a portion of the operator and protrudes toward the housing to be inserted into a recess portion formed by recessing an outer surface of the housing toward an interior of the housing, and
the return-side stopper comes into contact with a wall surface of the recess portion so that a rotation of the operator in the return direction is restricted.

4. The electronic wind instrument according to claim 3, wherein the recess portion is a through hole that communicates with the interior of the housing and the detection portion is arranged inside the housing, and
the return-side stopper also serves as an actuator that transmits a rotation of the operator to the movable portion by coming into contact with the movable portion of the detection portion through the through hole.

5. The electronic wind instrument according to claim 2, wherein a sum of the second reaction force and the third reaction force is 1.3 times or less the first reaction force.

6. The electronic wind instrument according to claim 5, wherein the return-side stopper is a portion of the operator and protrudes toward the housing to be inserted into a recess portion formed by recessing an outer surface of the housing toward an interior of the housing, and
the return-side stopper comes into contact with a wall surface of the recess portion so that a rotation of the operator in the return direction is restricted.

7. The electronic wind instrument according to claim 6, wherein the recess portion is a through hole that communicates with the interior of the housing and the detection portion is arranged inside the housing, and
the return-side stopper also serves as an actuator that transmits a rotation of the operator to the movable portion by coming into contact with the movable portion of the detection portion through the through hole.

8. The electronic wind instrument according to claim 2, wherein a sum of the second reaction force and the third reaction force is 0.7 times or more the first reaction force.

9. The electronic wind instrument according to claim 1, wherein the operator comprises at least two operators that are a second operator and a third operator,
the detection portion detects switching between a pressed state in which the operator rotates in the pressing direction and a non-pressed state in which the operator rotates from the pressed state to the return direction based on a movement amount of the movable portion and the detection portion comprises at least two detection portions that are a second detection portion and a third detection portion,
the electronic wind instrument comprises an interlocking mechanism that moves a movable portion of the second detection portion by a rotation of the second operator and moves movable portions of both the second detection portion and the third detection portion by a rotation of the third operator, and
in a rotation range of the third operator, there exists a range where the third detection portion detects the pressed state while the second detection portion detects the non-pressed state.

10. The electronic wind instrument according to claim 9, wherein the return-side stopper is a portion of the operator and protrudes toward the housing to be inserted into a recess portion formed by recessing an outer surface of the housing toward an interior of the housing, and
the return-side stopper comes into contact with a wall surface of the recess portion so that a rotation of the operator in the return direction is restricted.

11. The electronic wind instrument according to claim 10, wherein the recess portion is a through hole that communicates with the interior of the housing and the detection portion is arranged inside the housing, and
the return-side stopper also serves as an actuator that transmits a rotation of the operator to the movable portion by coming into contact with the movable portion of the detection portion through the through hole.

12. The electronic wind instrument according to claim 1, wherein the return-side stopper is a portion of the operator and protrudes toward the housing to be inserted into a recess portion formed by recessing an outer surface of the housing toward an interior of the housing, and
the return-side stopper comes into contact with a wall surface of the recess portion so that a rotation of the operator in the return direction is restricted.

13. The electronic wind instrument according to claim 12, wherein the recess portion is a through hole that communicates with the interior of the housing and the detection portion is arranged inside the housing, and
the return-side stopper also serves as an actuator that transmits a rotation of the operator to the movable portion by coming into contact with the movable portion of the detection portion through the through hole.

14. A method for providing operation feel of an operator in an electronic wind instrument that comprises a housing; an operator supported on outside of the housing to be rotatable in a pressing direction approaching the outside of the housing and a return direction opposite to the pressing direction; a detection portion detecting an operation to the operator; and a return-side stopper restricting a rotation of the operator in the return direction,
wherein the detection portion comprises a movable portion that moves with a rotation of the operator and an elastic body that generates a repulsive force for rotating the operator in the return direction via the movable portion,
the method comprising:
applying the repulsive force of the elastic body to the operator in a state where a rotation in the return direction is restricted by the return-side stopper.

15. The method for providing operation feel of the operator in the electronic wind instrument according to claim 14, wherein the operator comprises at least three operators that are a first operator, a second operator and a third operator,
the detection portion comprises at least three detection portions that are a first detection portion, a second detection portion and a third detection portion,
a movable portion of the first detection portion moves by a rotation of the first operator that is in contact with the movable portion of the first detection portion,
the electronic wind instrument comprises an interlocking mechanism that moves a movable portion of the second detection portion by a rotation of the second operator, and moves movable portions of both the second detection portion and the third detection portion by a rotation of the third operator, and
a second reaction force generated in response to a repulsive force of an elastic body of the second detection portion in a case of the second operator or the third operator being rotated in the pressing direction and a third reaction force generated in response to a repulsive force of an elastic body of the third detection portion in a case of the third operator being rotated in the pressing direction are respectively smaller than a first reaction force generated in response to a repulsive force of an elastic body of the first detection portion in a case of the first operator being rotated in the pressing direction.

16. The method for providing operation feel of the operator in the electronic wind instrument according to claim 15, wherein a sum of the second reaction force and the third reaction force is 1.3 times or less the first reaction force.

17. The method for providing operation feel of the operator in the electronic wind instrument according to claim 15, wherein a sum of the second reaction force and the third reaction force is 0.7 times or more the first reaction force.

18. The method for providing operation feel of the operator in the electronic wind instrument according to claim 14, wherein the operator comprises at least two operators that are a second operator and a third operator,
the detection portion detects switching between a pressed state in which the operator rotates in the pressing direction and a non-pressed state in which the operator rotates from the pressed state to the return direction based on a movement amount of the movable portion and the detection portion comprises at least two detection portions that are a second detection portion and a third detection portion,
the electronic wind instrument comprises an interlocking mechanism that moves a movable portion of the second detection portion by a rotation of the second operator and moves movable portions of both the second detection portion and the third detection portion by a rotation of the third operator, and
in a rotation range of the third operator, there exists a range where the third detection portion detects the pressed state while the second detection portion detects the non-pressed state.

19. The method for providing operation feel of the operator in the electronic wind instrument according to claim 14, wherein the return-side stopper is a portion of the operator and protrudes toward the housing to be inserted into a recess portion formed by recessing an outer surface of the housing toward an interior of the housing, and
the return-side stopper comes into contact with a wall surface of the recess portion so that a rotation of the operator in the return direction is restricted.

20. The method for providing operation feel of the operator in the electronic wind instrument according to claim 19, wherein the recess portion is a through hole that communicates with the interior of the housing and the detection portion is arranged inside the housing, and
the return-side stopper also serves as an actuator that transmits a rotation of the operator to the movable portion by coming into contact with the movable portion of the detection portion through the through hole.
